(19) United States
(12) Patent Application Publication
(10) Pub. No.: US 2012/0233253 A1
(43) Pub. Date: Sep. 13, 2012

(54) METHOD AND SYSTEM FOR INTERACTING AND SERVICING USERS BY ORIENTATION

(76) Inventor: Christopher P. Ricci, Saratoga, CA (US)

(21) Appl. No.: 13/371,143

(22) Filed: Feb. 10, 2012

Related U.S. Application Data
(60) Provisional application No. 61/441,795, filed on Feb. 11, 2011.
(60) Provisional application No. 61/553,796, filed on Oct. 31, 2011.

(51) Int. Cl. G06F 15/16

(52) U.S. Cl. 709/204

(57) ABSTRACT

The present disclosure relates to a social networking service based on user orientation, particularly user political beliefs.

### CROSS REFERENCE TO RELATED APPLICATION

The present application claims the benefits of U.S. Provisional Application Ser. Nos. 61/441,795, filed Feb. 11, 2011, and 61/553,796, filed Oct. 31, 2011, each of which is incorporated herein by this reference in its entirety.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyright rights whatsoever.

### FIELD

The disclosure relates generally to interacting with users, particularly over the Internet, and particularly to interacting and servicing users by personal orientation.

### BACKGROUND

Every election, typical voters arrive at the polls knowing one, maybe two people that they plan to vote for. In a presidential year, a typical voter may know only his or her choice for president and nothing else. The voter is commonly faced with a largely unknown and/or confusing list of other names for offices, such as congressman, senator, governor, mayor, attorney general, and sheriff, and special initiatives, constitutional amendments, and ballot questions. In the few minutes available to cast the ballot, the typical voter responds by voting by party line and makes snap decisions about other issues on the ballot. This can lead to poor decision making by voters, dissatisfaction with the voting process, voter apathy, incomplete ballots, and delayed casting of ballots, causing long lines at voting precincts. The dissatisfaction of voters is believed to be the cause of low voter turnout. During the 2008 presidential election, only 62.4% of registered voters voted. This percentage is significantly lower in non-presidential elections.

Paper ballots, also known as a document ballot voting system, remain the most convenient and favored method for casting a vote. Paper ballots have flaws, as shown by well publicized elections in which cast paper ballots were incomplete, confusing to read, allegedly lost and relocated, and other similar issues. While electronic voting, which involves electronic means of casting a vote and/or of counting votes, is on the rise, it is still in its relative infancy in many countries due to fear of voting fraud.

### SUMMARY

These and other needs are addressed by the various aspects, embodiments, and/or configurations of the present disclosure. The present disclosure is directed to a computer architecture to enable or facilitate or service personal orientations of users. Although the embodiments below are discussed with reference to political orientation, it is to be understood that the disclosure can apply equally to other types of orientations, including religious and sexual orientations.

In an embodiment, a method and system are provided that perform the following steps/functions:

(a) receiving, by a processor executable orientation social networking service, a profile of a selected user, the profile indicating a set of orientations of the selected user;

(b) comparing, by the processor executable orientation social networking service, a selected portion of the selected user's profile against selected portions of profiles of a plurality of other users, the plurality of other users comprising users having a similar and/or dissimilar orientation to the selected user;

(c) identifying, by the processor executable orientation social networking service and based on the comparing step, a set of other users having a selected one of a similar and dissimilar orientation to the selected user; and

(d) forming a social network among the selected user and the set of other users, wherein the set of orientations comprises one or more of political belief, religious belief, and sexual inclination.

In one configuration, the set of orientations comprises a religious belief and the plurality of other users are members of differing social networks.

In one configuration, the set of orientations comprises a sexual inclination and the plurality of other users are members of differing social networks.

In one configuration, the set of orientations comprises a political belief, wherein the plurality of users comprise a plurality of voters, candidates, lobbyists, and influencers, and the plurality of users comprise members of differing political parties.

In the forming step, the social network among the selected user and the set of other users characterizes the selected user and the set of other users as one of friends, allies, and adversaries.

The social networking service can perform other steps/functions.

In one configuration, the network service:

compares a selected portion of the selected user's profile against a selected portion of a profile of a candidate and/or political party and/or ballot issue to determine a degree of at least one of similarity and dissimilarity between the selected user's orientation and an orientation of the candidate and/or political party and/or ballot issue, wherein the candidate and/or political party and/or ballot issue is selected for comparison by the processor executable orientation networking service based on a geographical and/or geopolitical location of the selected user; and

based on the comparing step, provides to the selected user a voting recommendation with respect to the candidate and/or political party and/or ballot issue.

In one configuration, the networking service:

provides news content to the selected user, the news content at least one of being selected by the user and based on the selected user's profile;

generates the profile based on the selected user's responses to a predetermined sets of questions respecting the selected user's political beliefs, each predetermined set of questions corresponding to a selected one of the political beliefs;

obtains, from a third party networked source, information for the selected user's profile, wherein the third party networked source is one or more of a selected user profile maintained by an on-line community, a personal website of the user, and a presence service associated with the user; and/or

maintains multiple blogs respecting opposing sides of a selected political issue, wherein blog recipients are selected based on user profiles.

When the generating step/function is performed, the selected user's response to the predetermined sets of questions can be weighted based on an assigned strength and/or importance and/or reliability of each response. The networking service can maintain separate scores for assigned strength and importance of each response. Multiple levels of predetermined sets of questions can have multiple reliability levels.

In one configuration, the networking service determines, from profiles of members of a selected set of the plurality of users, a profile of an average user. While the terms “average” and “standard” user are used primarily to reference aggregate membership profiles, this group is self-selected and may, not be representative of the “voting” population or the “total” population. In some applications, there may be a need for another correlation between the selected population and the general population. While the information may not be useful to the membership, it may be useful to candidate support or lobbyist organizations.

In one configuration, the networking service provides each of the plurality of users with a home page, the home page comprising a live news feed from a news source, a political compass indicating the respective user's political beliefs relative to at least one other user of the plurality of users and/or relative to an orientation, a first set of users designated as friends and/or prospective friends of the respective user, a second different set of users designated as one of current and/or prospective allies and adversaries of the respective user, and a blog selected based on the profile of the respective user, wherein different users can receive different blogs.

In an embodiment, a method and system are provided that perform the following steps/functions:

(a) comparing, by a processor executable orientation social networking service and/or a personal political advisor, a selected portion of a selected user's profile against selected information respecting a selected object, the selected object being at least one of a candidate, a member of an organization, a political party platform, a political issue, and a ballot issue; and

(b) based on the comparing step, providing, by the processor executable orientation social networking service and/or a personal political advisor, a voting recommendation for consideration by the selected user.

In one configuration, the selected object is at least one of a candidate for office and organization member and the selected information is at least a portion of a profile of the at least one of a candidate for office and organization member and the networking service determines, based on the comparing step/function, a level of similarity and/or dissimilarity between the selected user and the selected one of a candidate for office and organization member.

In one configuration, the selected object is at least one of a political party platform, a political issue, and a ballot issue and the networking service determines, based on the comparing step.function, a level of similarity and/or dissimilarity between the selected user and the selected one of a political party platform, a political issue, and a ballot issue.

In one configuration, the networking service:

receives a response, from the selected user, to the recommendation; and

provides the response to an election monitor as part of casting a ballot.

The present disclosure can provide a number of advantages depending on the particular aspect, embodiment, and/or configuration. The disclosed orientation social networking service can provide artificial intelligence to consolidate user views based on user input and enable private users to compare his or her political beliefs with candidates or other ballot issues to easily and accurately determine for whom or what he or she should vote, thereby providing higher levels of voter satisfaction and participation. It can provide voters with a sample ballot containing recommendations generated automatically based on a comprehensive user profile, thereby decreasing substantially voter confusion and frustration at the ballot box and voter disenfranchisement. It can provide instant transparency and accountability to elections. It can provide a convenient and secure vehicle for voters to cast electronically ballots, thereby raising levels of voter participation and decreasing instances of voter fraud. It, can provide a social media-type website allowing people of like beliefs to interact. It can keep members politically informed on a level of his or her choosing and promote meaningful, active communication. It can provide a convenient forum for all political stakeholders, such as voters, candidates, bill sponsors, influencers, businesses, and special interest groups, to interact. It can provide solid, objective evaluations of candidate positions. It can allow candidates to access his or her constituency while providing a platform to deliver his or her message. It can use its member database to provide more accurate polling information, thereby enabling candidates to have more direction and current feedback on how to represent his or her constituency. It can provide a vehicle for candidate fund raising efforts. It can provide a convenient forum for voter grass roots movements.

These and other advantages will be apparent from the disclosure.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”; and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

A “blog” (a blend of the term web log) is a type of website or part of a website supposed to be updated with new content from time to time. Blogs are usually maintained by an individual with regular entries of commentary, descriptions of events, or other material such as graphics or video. Entries are commonly displayed in reverse-chronological order.

A “blogging service” is a blog-publishing service that allows private or multi-user blogs with time-stamped entries.

A “candidate” is used broadly to refer not only to a person seeking an elected or appointed office but also a person currently holding an elected or appointed office (such as a politician).

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The terms “determine”, “calculate” and “compute,” and variations thereof, as used herein, are used interchangeably and include any type of methodology, process, mathematical operation or technique.

The term “electronic address” refers to any contactable address, including a telephone number, instant message handle, e-mail address, Universal Resource Locator (“URL”), Universal Resource Identifier (“URI”), Address of Record (“AOR”), electronic alias in a database, like addresses, and combinations thereof.

The term “electoral” or “voting system” refers to any type of political system and includes nonpartisan systems (in which no official political parties exist) (examples include Nebraska, Northwest Territories, and Nunavut, and Tokelau), single-party and dominant-party systems (in which one political party is legally allowed to hold effective power) (examples include China (single-party) and Singapore, South Africa, Samoa, Montenagro, and Mexico (dominant-party)), two-party systems (in which two political parties are dominant to such an extent that the electoral success under the banner of any other party is virtually impossible) (examples include Jamaica, Ghana, United Kingdom, and the United States), and multi-party systems (in which more than two parties are represented and elected to public office) (examples include Australia, Canada, Germany, Pakistan, India, Ireland, Norway, Republic of Ireland).

The terms “instant message” and “instant messaging” refer to a form of real-time text communication between two or more people, typically based on typed text.

The term “internet search engine” refers to a web search engine designed to search for information on the World Wide Web and FTP servers. The search results are generally presented in a list of results often referred to as SERPS, or “search engine results pages”. The information may consist of web pages, images, information and other types of files. Some search engines also mine data available in databases or open directories. Web search engines work by storing information about many web pages, which they retrieve from the html itself. These pages are retrieved by a Web crawler (sometimes also known as a spider)—an automated Web browser which follows every link on the site. The contents of each page are then analyzed to determine how it should be indexed (for example, words are extracted from the titles, headings, or special fields called meta tags). Data about web pages are stored in an index database for use in later queries. Some search engines, such as Google™, store all or part of the source page (referred to as a cache) as well as information about the web pages, whereas others, such as AltaVista™, store every word of every page they find.

A “lobbyist” refers to someone who is employed to persuade legislators to vote for legislation that favors the lobbyist's employer. The lobbyist's employer could be, for example, a political party or other political organization (such as a PAC), a corporation or other business entity, an individual, a candidate, and the like.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element. Also, while the disclosure is presented in terms of exemplary embodiments, it should be appreciated that individual aspects of the disclosure can be separately claimed.

The terms “online community”, “e-community”, or “virtual community” mean a group of people that primarily interact via a computer network, rather than face to face, for social, professional, educational or other purposes. The interaction can use a variety of media formats, including wikis, blogs, chat rooms, Internet forums, instant messaging, email, and other forms of electronic media. Many media formats are used in social software separately or in combination, including text-based chatrooms and forums that use voice, video text or avatars.

The term “orientation” refers to a general or lasting direction of thought, inclination, or interest. Examples of orientation include political views and beliefs, religious beliefs and a person's self-inclination, particularly heterosexual, bisexual, and homosexual.

A “party platform”, or “platform” sometimes also referred to as a manifesto, is a list of the actions which a political party, individual candidate, or other organization supports to appeal to the general public for the purpose of having said peoples' candidates voted into political office or the professed opinion(s) proposed as part of law(s) or otherwise made into social policies. This often takes the form of a list of support for, or opposition to, socially relevant, urgent, controversial, or complicated topics or issues. Individual topics, and a party's, person's, or organization's opinion on them are often called the “planks” of their platform in reference to a basic stage made out of boards or planks of wood, similar to what can be assembled for public speaking or debates to be held on.

The term “political action committee” or “PAC” refers to a group not endorsed by a candidate or political party but organized to engage in political election activities, such as the raising and spending of money for campaigning. Some PACs, for example, are organized solely to help defeat a candidate deemed undesirable by the group.

The term “political party” is a political organization that typically seeks to influence government policy, usually by nominating their own candidates and trying to seat them in political office. Parties participate in, electoral campaigns, educational outreach or protest actions. Parties often espouse an expressed ideology or vision bolstered by a written platform with specific goals, forming a coalition among disparate interests. Common types of political parties include cadre parties and mass parties. Examples of political parties include the Democratic and Republican parties in the United States and the Communist, Socialist, Green, Liberal, Christian Democratic, Conservative, and Libertarian families of parties in Europe. In politics, the line or the party line is an idiom for a political party or social movement's canon agenda, as well as specific ideological elements specific to the organization's partisanship.

The term “social network service” is a service provider that builds online communities of people, who share interests and/or activities, or who are interested in exploring the interests and activities of others. Most social network services are web-based and provide a variety of ways for users to interact, such as e-mail and instant messaging services.

The term “social network” refers to a web-based social network.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

FIG. 1 is a block diagram of an orientation social networking system according to an embodiment;

FIG. 2 is a block diagram of an orientation social networking service according to an embodiment;

FIG. 3 is a screenshot of a graphical user interface according to an embodiment;

FIG. 4 is a screenshot of a graphical user interface according town embodiment;

FIG. 5 is a screenshot of a graphical user interface according to an embodiment;

FIG. 6 is a screenshot of a graphical user interface according to an embodiment;

FIG. 7 is a screenshot of a graphical user interface according to an embodiment;

FIG. 8 is a screenshot of a graphical user interface according to an embodiment;

FIG. 9 is a screenshot of a graphical user interface according to an embodiment;

FIG. 10 is a screenshot of a graphical user interface according to an embodiment;

FIG. 11 is a screenshot of a graphical user interface according to an embodiment;

FIG. 12 is a screenshot of a graphical user interface according to an embodiment;

FIG. 13 is a screenshot of a graphical user interface according to an embodiment;

FIG. 14 is a screenshot of a graphical user interface according to an embodiment;

FIG. 15 is a screenshot of a graphical user interface according to an embodiment;

FIG. 16 is a screenshot of a graphical user interface according to an embodiment;

FIG. 17 is a screenshot of a graphical user interface according to an embodiment;

FIG. 18 is a screenshot of a graphical user interface according to an embodiment;

FIG. 19 is a screenshot of a graphical user interface according to an embodiment;

FIG. 20 is a screenshot of a graphical user interface according to an embodiment;

FIG. 21 is a flow chart according to an embodiment;

FIG. 22 is a flow chart according to an embodiment;

FIG. 23 is a flow chart according to an embodiment;

FIG. 24 is a flow chart according to an embodiment;

FIG. 25 is a graphical representation of a member profile according to an embodiment;

FIG. 26 is a graphical representation of a member profile according to an embodiment;

FIG. 27 is a graphical representation of a profile comparison according to an embodiment; and

FIG. 28 is a graphical representation of a profile comparison according to an embodiment.

### DETAILED DESCRIPTION

### Overview

The orientation social networking service, according to an embodiment, provides members with a variety of orientation-related services, including social networking, political research results and statistics, voting assistance, and voting tools. In one configuration, the orientation social networking service is a nonpartisan political social network site directly connecting voters with candidates. Although the term “voter” is used, there is no age or citizenship restriction or requirement that the member be legally entitled to vote. The service can model the member's beliefs so that they can be applied against any candidate's stated beliefs and voting record and/or against ballot questions. For instance, the service can apply the voter's personal beliefs to a group of candidates to determine for whom the voter should be voting and/or how a voter should answer ballot questions and provide a forum and mechanism for the voter to let his or her opinions be heard by his or her elected officials. In one application, this is achieved by integrating a social networking interface with artificial intelligence that models the member's beliefs. The service can enable members to access like-minded, members and groups of members, irrespective of party affiliation.

In this configuration, members are of several types. Typical members include voters, candidates for government or private political office, influencers particularly dignitaries, entertainers, professional athletes, and other public personages, luminaries, celebrities, and figures, lobbyists, and political action committees (which are considered to be a type of influencer). An influencer generally has the ability to influence normal members due to his or her popularity, notoriety, reputation, and/or financial status. News sources can also be members. News sources would receive statistics, such as projected election winners and voting distribution by party. The data can be broken out in numerous ways, such as geographically and/or demographically. Members can be grouped into allies (who are in agreement with a selected member on one or more selected issues), adversaries (who disagree with the selected, member on one or more selected issues), and friends (who, though classified as allies or adversaries, have a relationship with the selected member).

The orientation networking service is not limited to networking. The service can facilitate the public or private electoral process, whether in nominating or selecting a candidate to represent a political party or electing a candidate to office. The service can enable a voter to identify more readily candidates and positions on political and election issues that align with the voter's particular views and beliefs. It can provide a convenient and versatile interface between the voter and the election monitor for casting electronic ballots or votes. It can enrich and facilitate political discourse and associations between voters and provide a convenient forum for political expression.

The social networking capability of the system can also be beneficial for candidates and other political entities. The system can conduct general or selective polling on candidates, issues, or other political objects using the profiles of voters. The system can conduct general or targeted fund raising.

### The Orientation Social Networking System

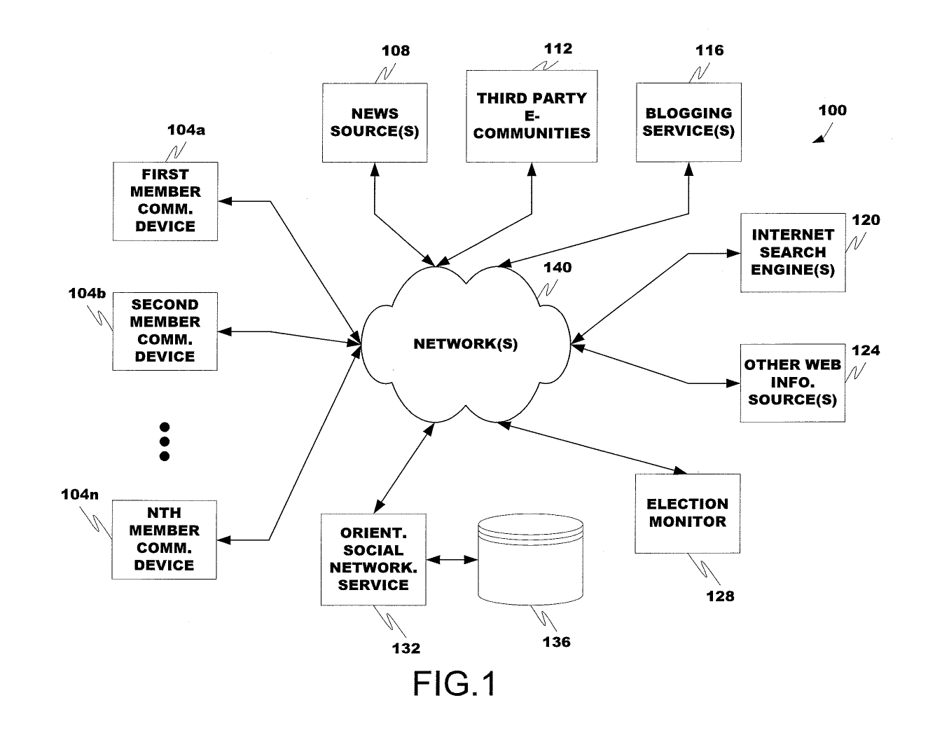

With reference to FIG. 1, the orientation social networking system 100 includes first, second, . . . nth member communication devices 104a-n, news source(s) 108, third party e-communities 112, blogging service(s) 116, Internet search engine(s) 120, other Web information source(s) 124, election monitor 128, orientation social networking service 132 and interconnected database 136, all interconnected by network(s) 140.

The first, second, . . . nth member communication devices 104a-n are associated with a member, such as a voter, candidate, influencer, or lobbyist, can be any network (e.g., Internet) capable communication device, such as a personal computer, laptop, notebook computer, tablet computer, cellular phone, personal digital assistant, or other computerized device.

The news source(s) 108 is a network capable news service that provides electronic information of interest to members. Examples include MSNBC™, Fox News™, Reuters™, ABC News™, NBC News™, CBS News™, CNN™, The Huffington Post™, The Weekly Standard™, Drudge Report™, Newsmax™, Time™, NPR™, Slate™, Newsweek™, U.S. News & World Report™, Politico™, The Heritage Foundation™, The Cato Institute™, Citizens Against Government Waste™, Media Research Center™ and Townhall™.

The third party e-communities 112 include any online community provider, such as a social network service. Examples of social networking services include with Facebook, Netlog, Myspace, and Twitter widely used worldwide, The Sphere (luxury network), Nexopia (mostly in Canada); Bebo, VKontakte, Hi5, Hyves (mostly in The Netherlands), Draugiem.lv (mostly in Latvia), StudiVZ (mostly in Germany), iWiW (mostly in Hungary), Tuenti (mostly in Spain), Nasza-Klasa (mostly in Poland), Decayenne, Tagged, XING, Badoo and Skyrock in parts of Europe; Orkut and Hi5 in South America and Central America; and Mixi, Multiply, Orkut, Wretch, renren and Cyworld in Asia and the Pacific Islands and Facebook, Twitter, LinkedIn and Google+ are very popular in India and Pakistan.

The blogging service(s) 116 can be any blogging or microblogging service. Examples include personal blog, corporate or organizational blog or genre blog (particularly a political or other orientation-type blog). The blogging service(s) 116 can include not only textual blogs but also vlogs, linklogs, sketchblogs, photoblogs, or tumblelogs. The blogging service(s) 116 can also include a reverse blog that is composed by its users rather than a single blogger. The blogosphere may be interconnected and socially networked, through blogrolls, comments, linkbacks, and backlinks or by online communities, such as BlogCatalog or MyBlogLog. The blogging service(s) 116 can include a blog search engine to search blog contents, such as Bloglines, BlogScope, and Technorati.

The internet search engine(s) 120 can be any type of search engine and is capable of collecting desired information, in real-time or near-real-time.

Other Web information source(s) 124 include a source for any other electronic information of interest to a member. Such source(s), for example, can be a governmental or organizational database including records, such as the congressional record, library of congress, legislative archives, presidential records, presidential archives, and archives of other governmental or private entities.

The election monitor 128 is an entity responsible for controlling and/or monitoring an electoral or voting system and/or tabulating votes or ballots. The electron monitor may be a governmental or private entity. A typical election monitor 128 is a voting, balloting, or election commission, office, or board.

The network(s) 140 can be any wired or wireless, public or private, trusted or untrusted distributed processing network, including, for example, a local area network, wide area network (such as the World Wide Web), and/or a regional network, or combinations thereof. A common network(s) 140 uses the Transport Control Protocol (“TCP”) and/or Internet Protocol (“IP”).

The orientation social networking service 132 includes an associated database 136 including electronic information related to selected objects, including without limitation members, news source(s) 108, election monitors 128, and electoral or voting systems, ballots, candidates, other political entities, and political issues.

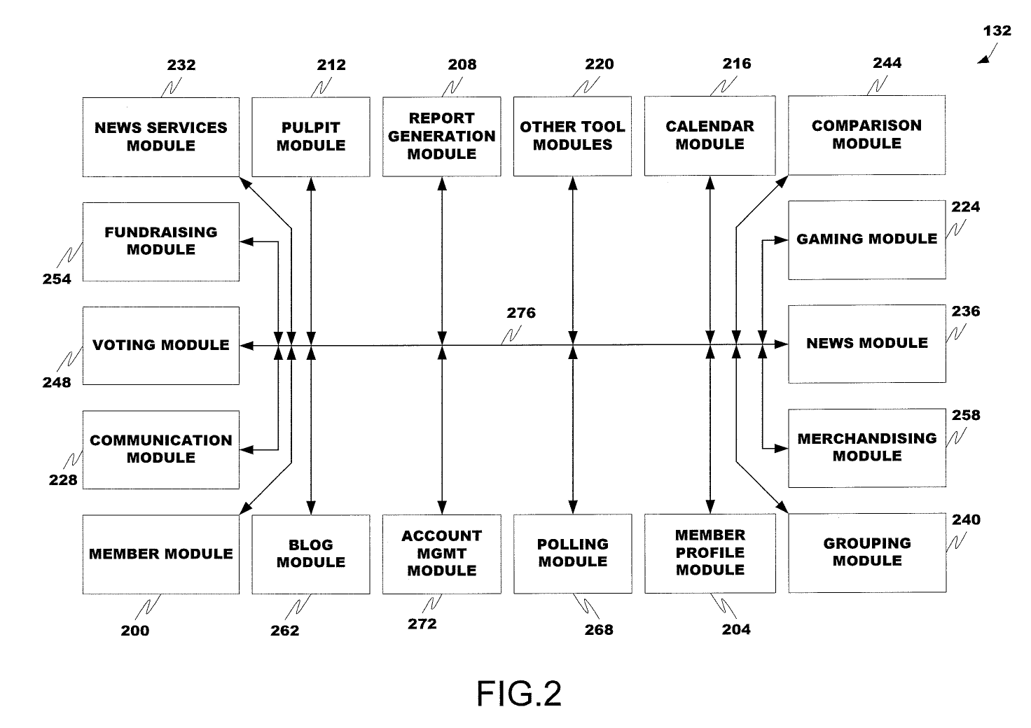

The orientation social networking service 132 will be discussed with reference to FIG. 2. Although the service 132 is described with reference to electoral or voting systems, it is to be understood that the service 132 may be applied to other orientations, such as religious and sexual orientations.

Referring now to FIG. 2, the service 132 includes a member module 200, a member profile module 204, a communication module 228, a voting module 248, a fundraising module 254, a news services module 232, a pulpit module 212, a report generation module 208, a calendar module 216, a comparison module 244, a gaming module 224, a news module 236, a merchandising module 258, a grouping module 240, a polling module 268, an account management module 272, a blog module 262, and other tool modules 220, all interconnected by a communications infrastructure 276 (such as a network and/or bus). Typically, the various modules are implemented as processor executable instructions stored on a computer readable medium.

The Member Module 200

The member module 200 provides customized services for members, which services can vary depending on member type or level (e.g., gold, silver, bronze). The member module 200 provides a personalized and/or customizable home page, or portal, for members to interact with other members and receive services. The member module 200 can, for example, provide a user with a home page that allows a customizable view. It can be personalized with his or her areas of interest. In one configuration, a portion of the display provides a news feed providing news on issues of interest. Another portion of the display provides fixed blocks dedicated for advertisement. Another portion of the display provides updates from groups and candidates of interest. In one configuration, the home page configuration further depends on the type of member. More simply, different member types have differing home page configurations, and differing members of a common member type can have differing customized versions of the member type home page configuration. In one configuration, the overall portal configuration for different member types is the same or similar, with the primary difference being what type of information is posted on the portal and what reports are available to the member.

The various home pages are typically configured around a social interface, which is generally a micro-blog. When a member is accessing the home page, the focus of the page is on posts from friends, groups they belong to, and candidates that are holding office or are running for election. The listing of candidates and other political issues provided can depend on the geographical or geopolitical location of the member. For example, a voter member in New York, N.Y., would have candidates occupying or running for election for political offices in or ballot issues germane, at the state and municipal level, to the city and county of New York and, at the federal level, to the senators and congressman representing or to represent the member and the president. When the member makes a post, the post may be directed, via the communication module 228 (discussed below), to the groups that the member belongs to or his or her candidates. A default position for the member can be his or her friends of like orientation. The service 132 can suggest new groups for membership by the member and new friends to be made by the member.

The member module 200 can provide the member with access to a website creator, such as Weebly, to publish his or her own website that is linked to or part of the service 132 site.

The Member Profile Module 204

The member profile module 204, which in one implementation is a called function or algorithm, collects personal information relevant to and establishes the voter member's profile, which serves as the basis for interacting with other members and receiving services. Typically, the user establishes his or her profile by answering predetermined questions on a set of political issues that established his or her basic positions. The questions are generally non-invasive. Progressively more comprehensive questions are provided for more customized profile levels. For example, the entry-level profile questions are much simpler and less accurate than more sophisticated or higher levels of questions. The questions can take many forms, including personal data (e.g., name, age, country and state/province of residence, physical address, race/ethnicity, contact information, contact preferences (e.g., electronic addresses of associated communication devices), solicitation preferences, and the like), political affiliation, demographics, fact scenario-based questions, policy-based questions, issue-based questions, and the like and may include a member-assigned weighting to enable the importance of the question to the member.

In one configuration, a first (entry-level) member level may use questions targeted at personal and economic beliefs, a second (intermediate) level at questions targeted at personal, economic and social beliefs, and a third (expert) level at questions targeted at personal, economic, social, and foreign policy beliefs. The difference between the three levels, besides the additional dimensions of the survey, includes larger numbers of questions, which are more detailed versions of the lower level(s). The questions may be presented in the same order as other level(s) to allow for easier comparisons among members at differing levels and for a more satisfactory member experience when the member wishes to change levels. In one configuration, the responses to the first member level questions are used to at least partially pre-populate, for approval by the user, responses to the second member level questions, and the responses to the second member level questions are used to at least partially pre-populate, for approval by the user, responses to the third member level questions.

The member profile module 204 can weight responses based on the member-assigned strength of the response, member-assigned importance of the response to the member's belief system, and/or a reliability factor (which can be calculated by the level of detail of the question or the level in which the question is included). The member profile module 204 can calculate aggregate values for each response for the highest completed level or across multiple completed levels. The member profile module 204 can then use the weighted and/or aggregated responses to determine an overall value for each of a plurality of belief objects. Exemplary belief objects and/or the number of questions for each belief object can vary by level. Belief objects generally fall into one of five categories, namely economic, international affairs, environment, and social issues. Exemplary questions within these categories include registered party affiliation and whether to have or permit government censorship, mandatory military service, drug legalization, national identification card, corporate entitlements from government, international free trade barriers, privatize governmental sponsored citizen retirement, private charity as a full or partial replacement for government welfare, lower taxation levels or rates, lower government spending levels or percentages, abortion, gay marriage, privately owned firearms, higher levels of military spending, government funded healthcare, foreign military involvement, barriers to immigration, barriers to foreign labor, offshore drilling, foreign policy restrictions, restrictions on natural resource development, government funded public works programs, stricter emissions standards, higher levels of funding for alternative energy research, stricter laws protecting labor unions, more deregulation, fewer regulations on business, stricter media regulation, stricter environmental regulations, more separation of church and governmental functions, higher minimum wage standard, English-only requirements, and stricter laws regarding racial discrimination for the second higher level.

Exemplary questions are as follows:
Should abortion be legal with the United States?
   Level 1—agree/neutral/disagree
   Level 2—agree/neutral/disagree+important/not important
   Level 3
      Abortion is legal in all situations
      Abortion is legal to save the life of the mother
      Abortion is legal in the case, of rape/incest
The Defense of Marriage Act is critical to the moral culture of America
   Level 1—agree/neutral/disagree
   Level 2—agree/netural/disagree+important/not important
   Level 3
      Marriage is only defined as between a man and woman
      Civil unions are acceptable
      Marriage can be between any two consenting adults
The Federal Government should manage the economy to ensure full employment
   Level 1—agree/neutral/disagree
   Level 2—agree/netural/disagree+important/not important
   Level 3
      The Federal Government should implement WPA-like policies when necessary
      The Federal Government should ensure that the financial system is solvent
The Federal Government should not legislative gun control measures
   Level 1—agree/neutral/disagree
   Level 2—agree/netural/disagree+important/not important
   Level 3
      Gun control is a state's rights issue
      Gun control is a social health issue

The use of the same question, with the same phrasing, can allow the responses to be compared easily among all levels and can provide a table format that can be tabulated or graphed. An example is as follows:

| | | | | | | | |
|---|---|---|---|---|---|---|---|
| Question | Level | Strongly | Agree | Neutral | Disagree | Strongly | Level of |
| | | Agree | | | | Disagree | Importance |
| | | | | | | | to Member |

The use of this scoring system provides granularity in comparing members, groups, or a member and group. Separate scores are maintained for the level of agreement/disagreement and strength of opinion on the issue (or the importance of the issue to the member). The separate scores can be combined, using suitable or no weighting factors, for a single question or for multiple questions relating to a common issue or averaged for all questions for all issues to provide a single value related to a composite view of the responses. Alternatively, a profile value graph (“PVG”) provides a graphic representation of possible opinions for a specific question or set of questions to be aligned on the axes. The PVG is transformed into numerical values by averaging the responses for a particular access using the bubble values, which automatically normalizes the data also. The output of the simple averaging along a PVG axis can be represented as a graph of distributions. The values are averaged across all axes, which results in a single number that is related to the composite view of the responses.

Averaging can also take into account the reliability factor. Where multiple levels of details are in the questions, reliability factors are determined. Assume that there are three levels of questions, such as:
Level 1—“Do you support the new Healthcare Plan?”
Level 2—“Do you support continuing Medicare for Seniors?”
Level 3—“Do you support the exclusion of pre-existing conditions from insurance policies?”
   Level 1 represents the short form response, assumed to be taken by someone who is not well informed. Levels 2 and 3 require responding to more questions and more detailed questions within the profile and, thus, are assigned a higher reliability factor when the individual responses are collated. The average reliability factor of all responses is indicative of how important a specific issue is to the responding member.

While voter (or standard) members are free to select any of the levels, some member types, such as candidates, influencers, and lobbyists, can be required to use a higher level to provide higher value to standard members. To entice standard members to progress to a higher level, additional member benefits can be offered free-of-charge or at reduced rates to members successfully completing a more detailed list of questions associated with a higher level.

By accessing the level field, the comparison module 244 (discussed below) can limit the comparison to only those questions that are pertinent.

In one configuration, the responses are used to generate a numeric representation of the member's belief system as it relates to a political party, such as a republican/hard core republican, democrat/hardcore democrat, libertarian/hardcore libertarian, moderate, neoconservative, or traditional democrat or republican.

In one configuration, each candidate has a “scorecard” for each selected legislative initiative or position for comparison, by the comparison module 244, against member profiles. The scorecard, in one configuration, assigns a numerical value on a 1 to 10 scale for each major issue. By way of example, if “0” represents pro life and “10” represents pro choice, and the candidate is pro life but would allow abortion for rape, incest, or to save the mother's life, then the candidate would be a “3” on that issue. As will be appreciated, other scales may be employed. The anonymous aggregation of results from comparing the scorecard to member profiles can be used for electoral predictions and sold to news outlets or third party polling organizations. Additionally, more expensive memberships can be offered to access such information.

In addition to the fields for political beliefs, the member profile includes additional fields. Examples of such fields include member name, gender, address, age or birthdate, ethnicity, party affiliation, update timestamp (to indicate when the profile was last updated), version of profile-determining question set completed, weighting factor, reliability factor, highest level or levels completed identifier(s), and a member “type” flag. Member types, as noted, include voter or standard member, candidate, influencer, and lobbyist. The flag can be used to ensure that the profile is excluded from aggregate opinions of selected groups of members as determined by the profile evaluation module 220 (discussed below), such as when determining voter profile input in constituency political polls.

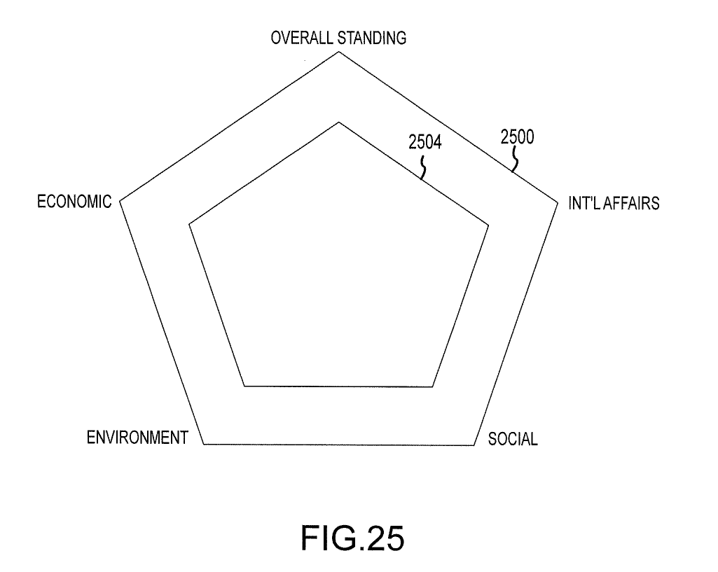

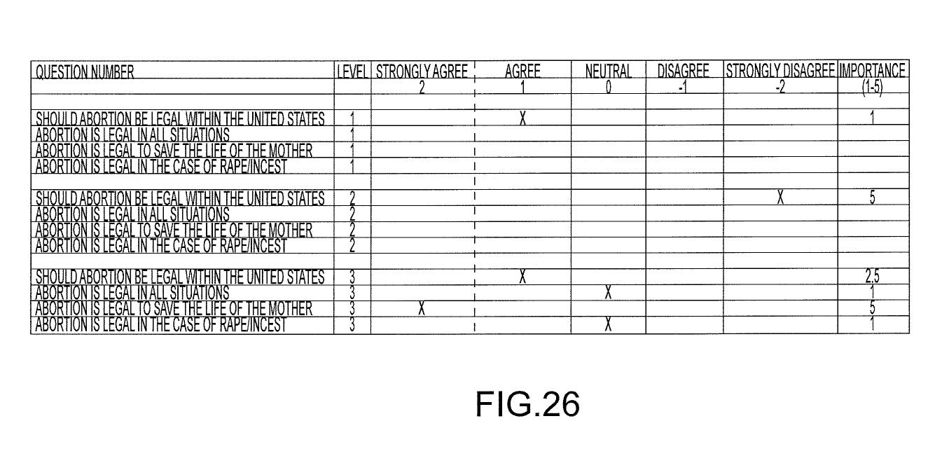

In one configuration, each profile level is charted, tracked, or presented to member(s) differently. For example, the first level is plotted in Cartesian coordinates on a standard X,Y chart. The second level is in the form of a pentagon or other geometrical shape, an example of which is shown in FIG. 25. In FIG. 25, the coordinate axes are denoted by reference 2500 and the plot based on the member's responses is shown by shape 2504.

In one configuration, the member module 200 data mines, from publicly available sources such as third party e-communities 112, blogging service(s) 116, and other Web information source(s) 124, information relevant to the member. The type of information mined depends on the member type. Information for a standard member, for instance, would be mined from other social networks, a personal web site of the member, a presence service associated with the member, and other sources and could include, for example, the member's preferences and non-preferences, hobbies, interests, identities of friends, contact information, political party affiliation, geopolitical or demographic information (e.g., identities of candidates currently representing or seeking to represent the member), vocation, socioeconomic status, and local, regional, and national political issues of interest or potential interest to the member. The collected information would be presented to the member for edit and/or approval.

For a candidate, the mined information and sources would include not only the information for standard members but also information related to the experience, beliefs, positions, and political record of the candidate. Such information could be mined, via an internet search engine(s) 120, from news source(s) 108, third, party e-communities 112 of which the candidate is a member, blogging service(s) 116, and other Web information source(s) 124. Examples of third party-source information includes the candidate's votes, speeches, position papers, voting records, interviews, affiliated political party planks, and sources of other types of public information.

In one configuration, the standard member has the unrestrained or unrestricted ability to edit his or her profile.

In one configuration, the candidate's ability to edit the fields would be limited or restricted depending on the field. For example, the candidate would be free to edit his or her personal information, preferences, and non-preferences, but would have limited ability to edit information received from a credible third party source, such as a voting record received from a public archive, active organization memberships (such as party affiliation, National Rifle Association membership, and the like), or prior employment record.

In one configuration, the candidate can log in to rate his or her own positions. An icon denotes “candidate comment” when the candidate disagrees with a rating or other position statement provided by the orientation social networking system. If a candidate's argument results in a rating change for that issue, a commentary moves to a candidate's blog or issues page and is taken down from his or her scorecard. There are also areas for the candidate to post his or her platform.

In one configuration, candidate members would have multiple profiles. A first profile is prepared entirely from input received from the candidate and/or a candidate representative. A second profile is prepared substantially or entirely from input received or mined from publicly available sources. A third comparative profile identifies differences between the first and second profiles. The candidate may be given the opportunity of providing input to the third comparative profile explaining the reason(s) for the differences. A reliability factor for the field value in the first or second profile can be determined based on the substantiality of differences between comparable fields of the first and second profiles. The factor would be a function of many factors, including the importance of the issue and the reliability of the corresponding field value in the second profile. Multiple profiles can prevent a candidate from skewing data and presenting an inaccurate profile.

A similar approach is used for political issues. The first profile is prepared entirely from input received from a political organization, such as an organization sponsoring or opposing proposed legislation or a ballot issue, while the second profile is prepared substantially or entirely from input received or mined from publicly available sources. A third comparative profile identifies differences between the first and second profiles.

The profiles for candidates, influencers, lobbyists, and political issues can include other information not included in standard member profiles. For example, the profiles of the former entities can include endorsement information, percentage of votes attended, percentage of votes on major issues attended, candidate's advertised position and the actual data relevant to the position, the opposition's advertised negative stance, and the actual data relevant to the position, voting record on major issues related to stated positions, and notable companies and lobbying groups supporting the candidate.

The profile is updated automatically based upon the member “liking” or “disliking” blog or posted statements over time. The member profile module 204 recalculates the member's political leanings on a regularly scheduled basis (e.g., daily, weekly, monthly, annually, etc.). The updating period can be altered by the member.

The member profile module 204 can time stamp the updates as profile answers can age over time. If someone answers a question today and then fails to interact with the service 132 for a prolonged period, the member profile module 204 would de-rate the answers as being non-current. The timestamp and age factor enable the service 132 to add new questions and/or age old ones, forcing members to answer newer questions.

In another configuration, updating is performed in response to keyword or keyword phrase identification in the member profile and/or an external information source, such as determined by an Internet search engine(s) 120 or other Web information source(s) 124. In either or both cases, keyword and/or keyword phrase identification can be used to identify out-of-date or hot new issues. The use of determined keywords and/or keyword phrases is therefore an indication of when the selected field in a member's profile was last updated.

The member profile can include a flag or other, indicator indicating whether or not the member wishes to be notified of changes to the profile-determining questions or when additional profile-determining questions are added to the survey. When the member does not wish to be notified of such changes or additions, the reliability factor will decrease for all responses each time one or more questions are changed or added.

The service 132 can contact a member, such as by instant message, email, and the like, that a new question is available and requires input. The member's reliability factor value is lowered until the question is responded to. If the member were to log in and fail to answer the question, the reliability factor value can be lowered again. This reduces a casual using member's influence on aggregate opinions of selected groups of members and ensures that active using members responding to changing positions influence the aggregate opinion.

The profile-determining questions can vary based on geopolitical location. For example, if a ballot question in Iowa requires the service 132 to know the member's position on ethanol, it would be flagged as a new question only for those whose profile indicate they are from Iowa.

In one implementation, member profiles include privacy settings that are commonly member configurable. The member would have the option of designating selected information in the profile as being “public” for presentation to all members and groups or “private” for presentation to only selected members or groups. For example, a member can opt to allow or disallow candidates and other member types to view his or her profile. Once a member has “friended” another member, the “friended” member can view the member's profile. As far as groups or candidates (and other premium members) contacting other members, premium members cannot see restricted profiles but can contact such members through the service 132 as constituents or like-thinking people. The member can opt out of receiving such contacts.

Another privacy setting in the profile is whether groups of like-thinking people can send friend requests. The users will have the option to receive them. The default will be to allow them.

In one implementation, a member can comment on profiles of non-standard members, particularly candidates. Such comments include not only posted comments but also posted links.

The member profile module 204 is commonly a called function. In this manner, the member profile module 204 can add/modify/delete questions and perform other updates regularly and reliably. To ensure that the member user has up-to-date entries, the user should be prompted to answer new/changed questions when he or she logs into the site. The reliability factor can be incorporated into the database design to “weed out” answers to questions that are not up-to-date. This will ensure that the database stays relevant.

The Comparison Module 244

The comparison module 244 compares a member's profile against a selected object or set of objects, such as a profile of another member, a political party platform, a political issue, and the like. For example, the comparison module 244 can compare a first (standard) member's profile against a second (standard) member profile, assign a “similarity” or “difference” level to the compared profiles, and use the level to determine whether the selected first and second members qualify as political “allies” or “adversaries”. The comparison module 244 can compare a selected (standard) member's profile against a ballot to providing a recommendation of how the selected member should vote on each choice on the ballot. The comparison module 244 can compare a selected (standard) member's profile against one or more candidate profiles, assign a “similarity” or “difference” level to the compared profiles, and use the level to determine whether the selected member should vote for or against one or more of the candidates. The comparison module 244 can compare a first (candidate) member's profile against one or more other candidate profiles to determine the differences between the selected candidates. The comparison module 244 can compare a first political party's profile or platform against a second political party's profile or platform to determine the differences between the selected candidates. The comparison module 244 can compare a selected (standard) member's profile against a selected bill or other item of legislation, assign a “similarity” or “difference” level to the compared objects, and use the level to determine whether or not the selected member should support (e.g., vote for or against) the selected bill or other item of legislation. In any of the above examples, the difference could be quantified as a “similarity” or “difference” level and/or as a description of the differences or similarities on an issue-by-issue basis. The “similarity” or “difference” level can be determined on any basis. In one configuration, each profile has an assigned score on each of a number of political issues, and the comparison simply compares the scores on like issues and computes a mathematical difference. A difference of less than a selected threshold is deemed to be “similar” while a difference of greater than a selected threshold is deemed to be “different” or vice versa.

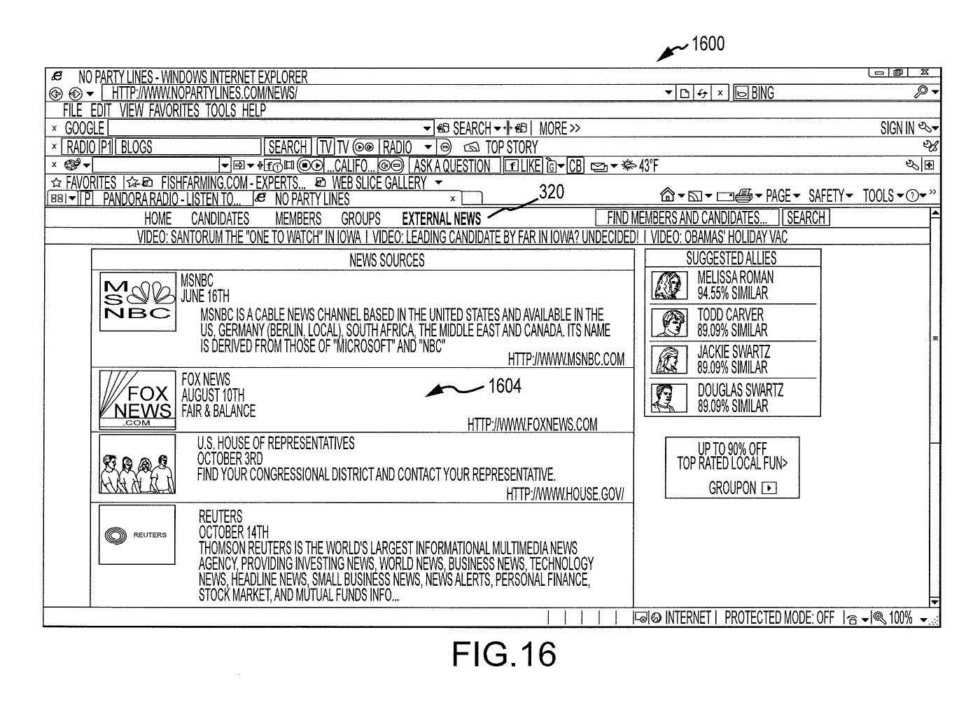

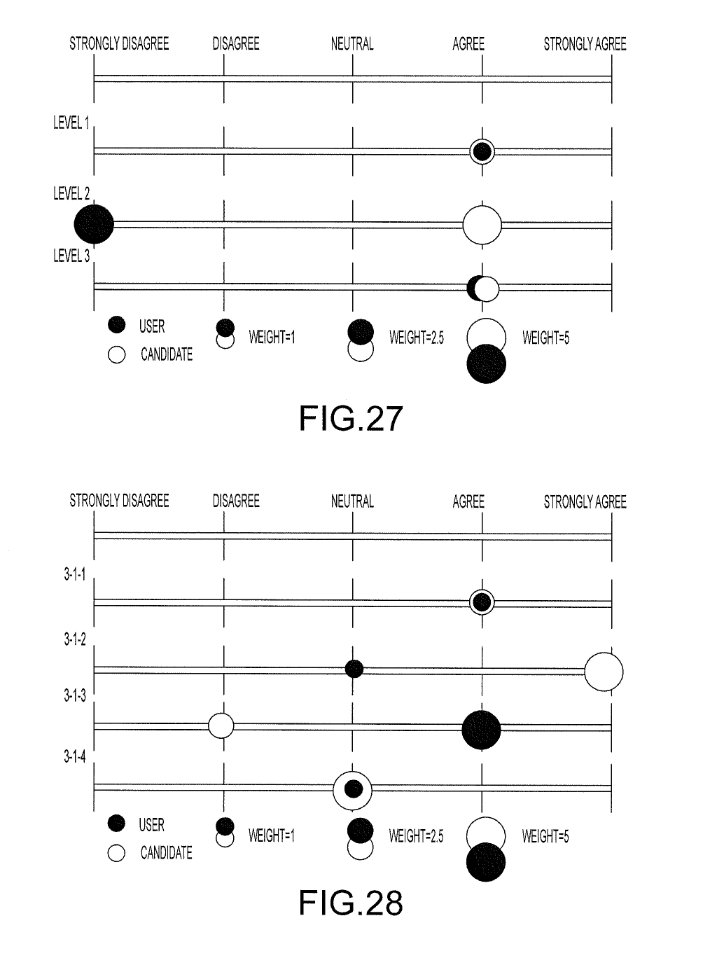

In one implementation, visual mapping of the comparison of the (standard) member's response to the candidate's (or issue organization's) response provides the most powerful way of representing the results. Using, as an example, the (standard) member results that are illustrated in FIG. 16, the results for all three levels result in the following set of mappings (only one mapping level is shown to the member). In FIGS. 27-28, the candidate and the user are aligned in their views for Level 1, as is the case for the Level 3 member. In both of these cases the “overlap” or “closeness” or “similarity” level is 100% (i.e., complete alignment). In the case of the level 2 member, there is no alignment. It is noteworthy about the relationship between the mapping and the underlying data records that the order of “strongly agree” is swapped between the data records and the visual representation (i.e., big endian/little endian). This is done for visual purposes on the survey and the fact that “negative” numbers are usually on the left of a graph. When the member has chosen Level 3 as the participation level, then all the questions are mapped.

Pattern recognition can be applied if a recommendation set is required. The pattern established for answers to all questions is compared to those of each of the candidates to determine a “closeness” or “similarity” or “difference” factor or level. The factor or level is used to determine who is closest in terms of like thinking. Thus, the “closeness” factor or level is a measure of how many of the questions match the user's responses, based on the visual mapping of the results.

When the comparison is being done using Level 2 or 3 questions, then in some configurations criticality comes into play. Only those questions deemed critical are put together to form a second pattern and then pattern matched against the same questions from the candidates. This creates a closeness score or level on critical issues.

This can also work for comparisons between levels. That is, if a candidate member is a Level 1 and the voter member is a Level 3, then all of the candidate's issues are deemed critical. In the case of a Level 2, issues are either “critical” or “not interesting.”

In one implementation, the member user is able to set, on a question-by-question basis, the level of “closeness” or “similarity” factor or level required for a compared object to be deemed to be “similar” or “different”. For example, a ‘rabid’ user who requires absolute adherence to a selected position (e.g., “teaparty”), such as adherence to a party platform or other set of issues, then the user could select 100% as the “closeness” or “similarity” or “difference” parameter or level. A more moderate user might select a 50% “closeness” or “similarity” or “difference” parameter. The “closeness” is a measure of how many of the questions match the user's responses, based upon the visual mapping of the results. The “closeness” comparison can simply be done on the answer or it could be expanded to include the weight of each answer ((standard) member and candidate).

This particular format also allows an “average (standard) member” to be defined. The average user is used to answer questions that candidates, groups, or news agencies may have. That is, when a candidate is curious how his/her constituency would feel about a certain issue, they can query the “average user”.

The “average (standard) member” (or user) can be plotted on the same graph (using a different color to represent the position and the weight). To calculate the average user, a constant is added to the value for the position in order to make the calculations simple. To do the calculation, one adds a constant (C₁) to the value associated with the position (Vᵢ) for each question.

Then the “average user”=(Σ_{i=1 to n}(Vᵢ+C₁)*Wi−Σ_{i=1 to n}C₁*Wi)/N.

The “average user” can be calculated for a particular, type, of affinity (which could be gleaned from demographic data) or just a geographic area. More interestingly, while the “average user” concept is usually thought of as applying to a particular election, there is sufficient data in the user profiles to allow selection of a set of users to represent any “user” that is required.

The concept of a “standard user” can be extended to artificial affinities, such as republican/hardcore republican, democrat/hardcore democrat, libertarian/hardcore libertarian, moderate, neoconservative, or traditional democrat. In this case, the system 132 can either select users who self describe themselves into one of these affinities and average their answers or create a set of answers that represent these positions. This answer profile can then be compared against the user's answers in the visual mapping.

The comparison module 244 for making comparisons among “standard user”, “current” user, and candidate is commonly a separate function.

The Communication Module 228

The communication module 228 enables intra-service communications between/among members and provides security.

The communication module 228, in one configuration, enables live (text, audio, and/or video) chat, typically with a limited number of participants unless a subscriber joins and configured as a separate topic-specific chat rooms, email (e.g., private messages, email notifications, and email invitations), instant messaging, micro blogs, and other inter-member communication modalities.

The communication module 228 can use multiple layers of security. Some of the security measures are technical while others are built into the business process to combat online fraud, phishing, and information theft. In one configuration, all communications between the user and the system are encrypted with a 256 bit SSL key. In one configuration, Secure Sockets Layer (“SSL”) certification is employed.

The Voting Module 248

The voting module 248 provides a vehicle by which votes or ballots can be cast by members electronically, over the network(s) 140, with an election monitor 128. This can be accomplished using sophisticated security systems, high speed servers, and special certifications from the election monitor 128.

In one configuration, the voting module 248, based on comparison results provided by the comparison module 244, provides a (standard) member with one or more voting recommendations. This can be done, for instance, on a sample ballot that simulates the actual ballot. The sample ballot can be accessed physically or electronically during voting to enable the member to cast his or her ballot more quickly.

The Fundraising Module 254

The fundraising module 254 can be used by candidate, influencer, or lobbyist members to perform fundraising activities. This can be done by targeted communications to a selected set of members or untargeted communications to all members.

The fundraising module 254 can be an easy way for candidates to collect campaign donations. There is a credit card interface that allows easy charging of donations. The service 132 retains a percentage of all donations (not modeled).

The service 132 provides an on demand accounting to the candidate and the users for ease of record keeping and ensures that the users do not accidentally exceed federally mandated donation limits. Accounting has two pieces. First, from a voter perspective, most donations are tax deductible. If all donations are done through the site, then it is easily accounted for come tax season. From the candidate's perspective, there are federal limits on how much can be raised from individuals. Thus, by making sure everything is done through the site we can enforce the limitations and provide a simple accounting for their records.

The News Services Module 232

The news services module 232 provides news information to members, such as news feeds, candidate, legislation and other political and geopolitical information, and the like. For example, the news services module 232 provides news feeds from news sources 108. The news services module 232 provides links to other websites of interest, particularly political websites such as Drudge Report, Michelle Malkin, National Review Online, Townhall, The Weekly Standard, Daily Kos, Huffington Post, LiberalOasis, MoveOn.org, the Nation, FactCheck.org, Project Vote Smart, Political Base, and Spot-On. It can provide lay explanations of legislation, referendum questions, and other complex political issues with icons redirecting the user to the actual legislation. It can also provide icons associated with the issues. For example, any time a user chooses any issue/referendum question/government debate, etc., as a variable for viewing a candidate, an icon is highlighted that provides a list of all organizations involved in support or opposition with links to each. Another icon may be articles that are relevant to the issue or links to other sites that may include more information on that issue.

The Pulpit Module 212

The pulpit module 212 maintains a discussion board or forum that is used for debates between members. A topic is posted and members jump in the ring to debate. Each member is allowed a set number of comments (˜10). After observing the discussion board or forum, other members then vote, such as by on-line voting, on a winner. Comments can be individually “liked” too. A winner is tallied and posted.

The Report Generation Module 208

The report generation module 208 provides members, particularly premium members, with access to multiple reports, such as demographic breakdown of a candidate's constituency, political positions of the candidate's constituency, electorate's view of the candidate, as compiled from posted comments, and predictions of how the electorate would vote on an issue or candidate.

The Calendar Module 216

The calendar module 216 maintains an electronic calendar that posts activities of interest to members, such as reminders, updates, and notifications of upcoming votes and local activities related to issues the user has flagged as being of interest. The calendar can be provided as iCal and RSS feeds.

In one configuration, members have the ability to edit or update the calendar module 216 to include events or other activities of interest, particularly in the member's community or to a user defined set of members. A geo-pod feature can be used in which the geographic location of the member is used by the system 100 to selectively publish the contents of the member edited calendar to other members. This would prevent members in New Jersey, for instance, being informed of political events in California. The geographic location of the member can be obtained from the member's profile and/or from his or her cellular phone, personal digital assistance, or other communication device.

The Gaming Module 224

The gaming module 224 provides members with the opportunity to play politically oriented games. For example, a member creates an avatar that represents him or her in the game. The default profile of the avatar is the member participant's profile. The avatar is then elected at a town level, and the member participant must run the town. The problems would mirror those faced by actual government. Once the member participant reaches a predetermined success level, he or she is invited by his or her political party to run at the next level. Levels can be posted to the participant's friend group.

The News Module 236

The news module 236 provides news updates on friends or allies or candidates of interest.

The Merchandising Module 258

The merchandising module 258 interacts with members and sells or provides at no charge political merchandise, such as signs, bumper stickers, t-shirts, posters, pins, badges, buttons, and the like. This module 258 provides a convenient way for candidates to distribute these materials to supporters. The module 258 can provide for more generic promotional materials that are comical, non-partisan, and all things political. For example, political books can be sold. On line auctions for political memorabilia can be performed.

There are countless national associations that concern themselves with the political landscape. These associations are potential members having “identity—message” related paraphernalia to be sold. i.e. PETA, NRA, MADD, CAGW (citizens against government waste), Pro-Life America, to name a few.

The Grouping Module 240

The grouping module 240, using grouping or profile comparison information supplied by the comparison module 244, from third party e-communities 112, and/or from a member, selects potential members and forms member groups, such as groups of like-minded members on an issue or set of issues. The stimulus for group formation may be by the service 132 or member request. In one configuration after potential member selection, the grouping module 240 notifies the selected potential members of the potential group and requests participation in the group. For example, the grouping may be issue- or candidate-focused. The grouping may be friendship-focused. Membership in a group or forum is typically determined by the demographic information in member profiles.

Unlike every other social networking site, the service 132 can have multiple nested social networks (SN). A first SN is a more typical network of friends. This is a group of people that the member knows. An import feature from a third party e-community 112 can be used by the service 132 to create friend lists. The prerequisite for being a friend is simply being known to the user. This is not unlike Facebook™, or many of various other third party e-communities 112. In addition, there is an SN of political allies. This is a group of members that the user shares common political ideals. These other members may or may not be people known to the user. Interestingly, first and second members may be allies on a first issue and therefore part of a first social network but be adversaries on a second issue and therefore part of separate second and third networks, respectively.

When a user connects with someone to join him to the user's social network, the user must designate that person as a “friend”, “ally” or both. A “friend” is just that, someone you know on a social level. That person may have politically dissimilar viewpoints. An “ally” is a like-thinking person that you may not even know. The user can designate, as an ally, a group such as the GOP.

In one implementation when a user wants to add “friends”, he or she is presented with the option of choosing to friend people within an order of influence from their own positions (from his or her profile) or is presented with names of people that he or she may know. In either case, the potential “friends” are presented based upon member profiles. Thus, a user may choose to “friend” all users that are socially liberal but fiscally conservative. Each friend will have icons associated with their names that indicate whether the user actually knows them or they are like thinking. In the case of the latter, the icons will differentiate whether his or her thinking is like based upon which criteria. Thus, if the user wants to post something that would only be of interest to his or her fiscally conservative friends, he or she may do so.

The social network allows users to communicate with whichever groups they wish. When a user posts a statement, the user selects one of three icons to share the statement. The first is the default, posting the statement to allies only. The second posts the statement to friends, which also posts the statement to Facebook and/or another third party e-community 112. The third posts the statement to “world”, which posts it to friends (including Facebook and/or other e-communities 112), allies, and Tweets it.

Stated another way, a user may communicate only with members of like views on some subjects, while bantering with others, including known friends. Sub-groups allow users to interact with like-thinking people without making them part of their network. For example, there may be a Tea Party group for those that are strongly in favor of tax reform.

In addition, there are “Group Allies”. For example, a local group could be formed to try to raise money for the local library. The members may not know each other (not friends) and may not share political commonality (not allies), but they share an ideal in that they all want to support the local library.

In the broadest of senses, even the first two groups can be viewed as “group allies”. Friends are simply a social group and political allies are a political group.

Each of these groups has the ability to interact among each other, create new groups, and seamlessly participate in an infinite web of social networks.

The grouping module 240 can form forums “social interaction”. Membership in a forum is commonly determined by the demographic information in member profiles. This restriction ensures that forum participants have a “stake” in the candidate or issue that they are commenting upon. A user must request membership in a specific forum, with eligibility determined based, for instance, on the user's demographic information. The demographic filter will be down to the ‘voting’ unit for that candidate or issue. For example, in a state representative race, the ‘voting unit’ would be the legislative district. A second example would be an issue that only affects certain precincts or wards in a given town. In the latter case, only residents of the precinct/ward would be allowed into the forum for the issue. A third example would be a governor's race for a specific state. In this case all eligible voters within the state would be part of the ‘voting unit’. This restrictive definition would not allow non-residents or political actions groups to become part of the discussion, thus biasing the scoring. Obviously the eligible ‘pool’ becomes larger as large ‘voting units’ are affected by a particular candidate or issue. A moderator function may be included in the forum to ensure that facts are correct and that there are no personal attacks among forum members or other improper behavior.

In other configurations, the grouping module 240, particularly at the initiation of the member rather than the service 132, establishes gross roots groups for individualized issues. Members generally create the new groups, which are therefore considered a Grass Roots effort. These groups would be made available to join and allow users to communicate amongst themselves. However, the group would generally not get access to the features of a grass root group without a premium membership. Examples of grass roots focus groups that would be posted would be in areas such as national (typically categorized by cause), local (typically categorized by cause), and international grass roots groups (subscriber postings only, typically listed by country, and/or categorized by cause).

The grouping module 240 can also establish issue-specific, socially conscious project groups or sub-networks. For instance, sub-networks of members can be established for socially conscious projects or causes for education, budgets (national/local), special education legislation, healthcare (e.g., childhood obesity, free clinics, and reform), environment (e.g., global warming, land preservation, and waste disposal), energy (e.g., pro/anti-nuclear, pro/anti-wind, regulations (e.g., emissions/licensing/FEMA), and humanitarian need (e.g., habitat for humanity, homeless, and anti-racism).

In one application, differently minded members of different sub-networks are able to provide communications anonymously with one another. Such bantering can enrich political discourse and user experience.

The Polling Module 268

The polling module 268 performs formal and informal polls of defined sets of (typically standard) members. The polls may be requested by another member, particularly a candidate member, influencer member, lobbyist member, or news source member, on a fee basis or as part of a membership. For example, a candidate may float questions through straw polls to all or a selected group of members. He or she might ask how his or her constituency would want him or her to vote on a new power plant in town. The questions can be posted as anonymous questions that may be from a polling or news agency, the candidate, or the service 132. This can provide the candidate with invaluable feedback without fear of being criticized for indecisiveness on issues.

The polling module 268 can tie into sites, such as Real Clear Politics (“RCP”)™ and Rasmussen's Reports™ as they regularly have polls. Such polls can be used, by the reporting module, to compare membership polling results against selected regional or national polling results.

The polling module 268 can also be used to fine tune the membership. In other words, the polling module 268 can compare the polling results of the membership against a regional or national polling result.

The Account Management Module 272

The account management module 272 performs a plurality of functions related to member services. The account management module 272 can establish and manage plural membership levels for a given type of member or, for all members. For example, premium memberships can be offered to candidate, influencer, and lobbyist members. For example, premium memberships for candidate members can, permit them to gain access to data, such as polling data, and convey messages to other (standard) members. For example, candidate premium members can comment on his or her positions as reported by the service 132 and make those comments available for member review. The candidate premium members can also view polling results to see how members view the candidate's positions. Candidate premium members, can also post statements that will appear on the home page of members. Premium memberships for influencer members can permit them to express opinions and post endorsements. Premium memberships for lobbyist members can permit them to express opinions and use a grass root functionality of the system 100 to get other (standard) members organized around issues.

The Blog Module 262

The blog module 262 creates one or more blogs for members to comment on socio-political issues. In one configuration, there are three blogs, namely Left, Right, and Center. As these names suggest, the blogs are purposely politically slanted. Users may follow one or more and post responses to them. The blogs are periodically updated with new issues to maintain the blog current. Older blogs will be archived and searchable by subject.

In one configuration, the blog module 262 posts the Left, Right, and Center blogs weekly. A comments section will follow for all users to post comments on. Further, users may simply Like/Dislike the blog and/or the posts. Any post that receives more than ten Dislikes and the Dislikes outnumber the Likes by 5:1, will be automatically removed from the comment section. A statement that the removal was due to an inordinate amount of dislikes will then be posted in its place.

In one configuration, the blogs include a standard “Reader Comments” section that follows most blogs. Along with the User name being posted, the icons indicating their political views are posted with the comment. With each post, the person posting will be asked whether they agree with the blog, disagree and how strongly they feel. This will create real time statics associated with the particular blog and also allow readers to filter the posts that they read if they so choose. That is, if the blog generates a visceral reaction from neo-conservatives then more moderate users may wish to filter those posts as they read.

There is also a “Challenge section that allows one user to challenge another to a debate, as moderated by the pulpit module 212 above. The debate is limited to a predefined number of statement and responses. The user community then votes on a winner. The number of debates participated in and won become additional user metrics. The number of debates participated in and won become additional user metrics in the member's profile.

The blogs are used to create controversy and drive active participation in the service 132. The member profile module 204 can add the responses to or use the responses to update member's profiles. For example, a member can be rated by the member profile module 204 as activists based on his or her participation. A Member can receive an award to show to other members indicating the member's level of active participation in the service 132.

Other Tool Modules 220

Other tool modules 220 provide other services to members. For example, other tool modules 220 can provide quick access to local and state government rosters, email addresses, form letters, and the like.

In a further example, advertising and targeted emails to all or a selected group of members can be used to advance a candidate's interests. The advertising generally follows a standard structure. The emails can be targeted, such as only to those members who are undecided on an issue (e.g., rated or scored a “5” on an issue in the member's profile) or those that the candidate feels may not see the benefit to them (e.g., members that live in proximity to a proposed garbage dump that may get property tax breaks as a result of the property use).

In a further example, other tool modules 220 enable members to set up a personal web site and candidates to link to the personalized web sites. The service is available for other politically active groups, such as university groups, religious groups, and local gross roots efforts. Members may select groups to follow, ones of which they are/were members or simply agree with. These designations can be used by the member profile module 204 to update member profiles.

In a further example, the service 132 maintains discussion boards and forums to foster political discourse. The service 132 can purposely populate discussion boards and forums with controversial statements to foster member discussions.

In a further example, candidates can post statements that will appear on the home page of his or her electorate. A video capability also allows the candidate to conduct live “town hall meetings” and answer member's questions. It can further allow live feed capability of all speeches given on the campaign trail.

Member Portals

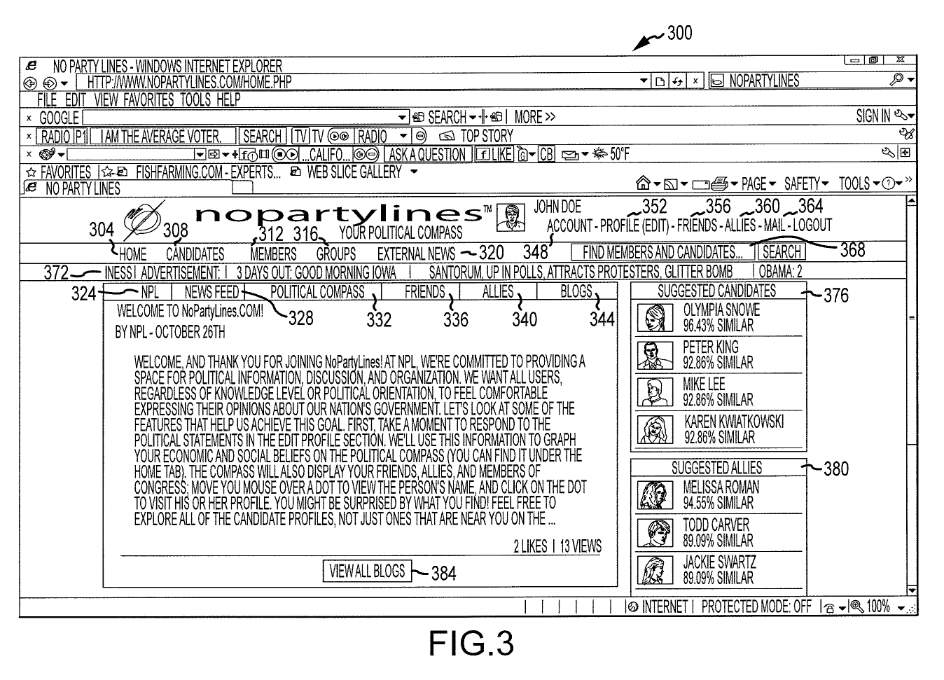

An example of the portal for a representative member, John Doe, is illustrated in FIG. 3. The portal 300 includes a number of member selectable links, including home 304 (which is the home page), candidates 308, members 312, groups 316, external news 320, NPL 324, news feed 328, political compass 332, friends 336, allies 340, blogs 344, account 348, member profile 352, friends 356, allies 360, mail 364 (which can be email services provided by the service or a third party), and logout. The portal 300 further includes a search field 368 to permit the services site to be searched, a news feed 372 providing a streaming news feed on issues of interest to the member, a listing 376 of profiles of suggested candidates and a listing 380 of suggested allies for the member to consider. A further member selectable link 384 enables the member to view all blogs. Advertising fields may be included in the portal for purchase by members or vendors.

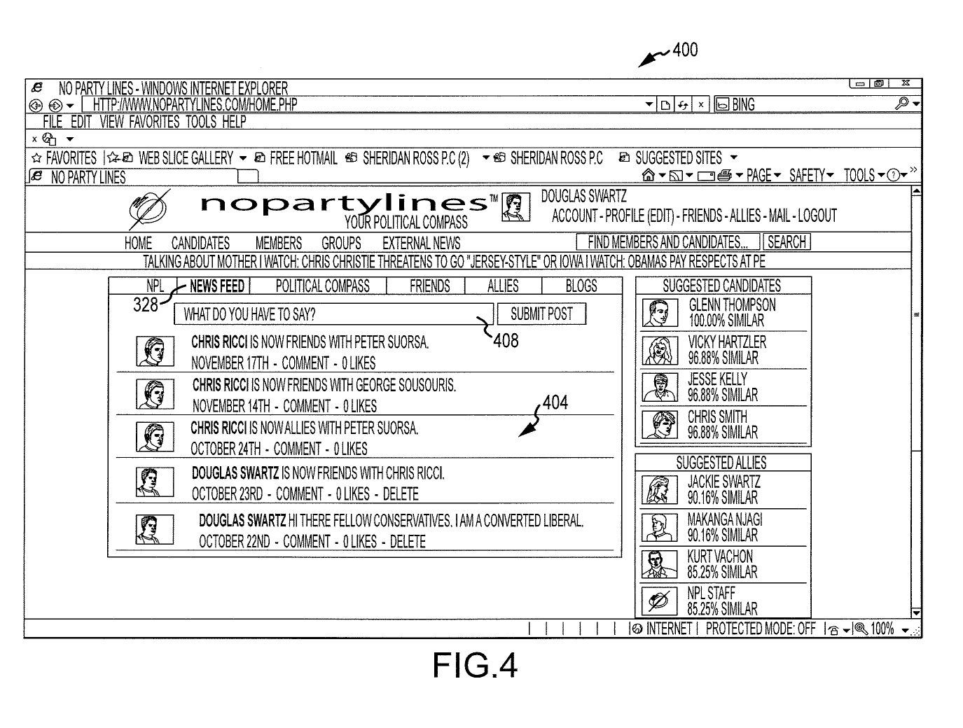

FIG. 4 shows the web page 400 provided when the news field 328 link is selected. News updates 404 on friends or allies or candidates of interest are provided. A post field 408 permits the member to post comments to the news updates, which are then filtered by the member's preferences. The member may indicate that they like another member's post, which will prioritize his or her future posts to the member. Likewise, the member may indicate a dislike, which will lower the priority of the member on the list. Over time, individualized groups can be formed among members of similar philosophies and interests. Posts on blogs can also be liked and disliked and such selections form part of the member's profile.

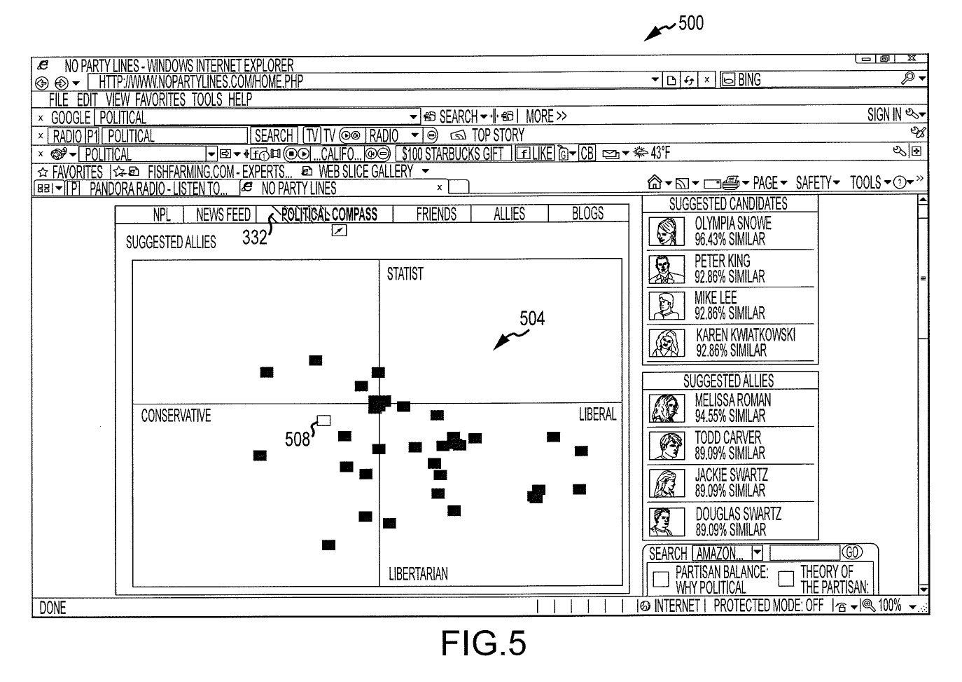

FIG. 5 shows a first portion 500 of a web page provided when the political compass field 332 link is selected. The political compass plots each member's composite profile score on a political matrix to indicate visually the degree to which the member is statist, conservative, liberal, or libertarian. The point 508 represents the point for the requesting member (John Doe). Each other point in the matrix indicates the point for another member in the service 132. By hovering over the point with a cursor, the name of the corresponding member appears. The point is a link to the other member's public profile. By selecting the point, the other member's profile is provided to the requesting member.

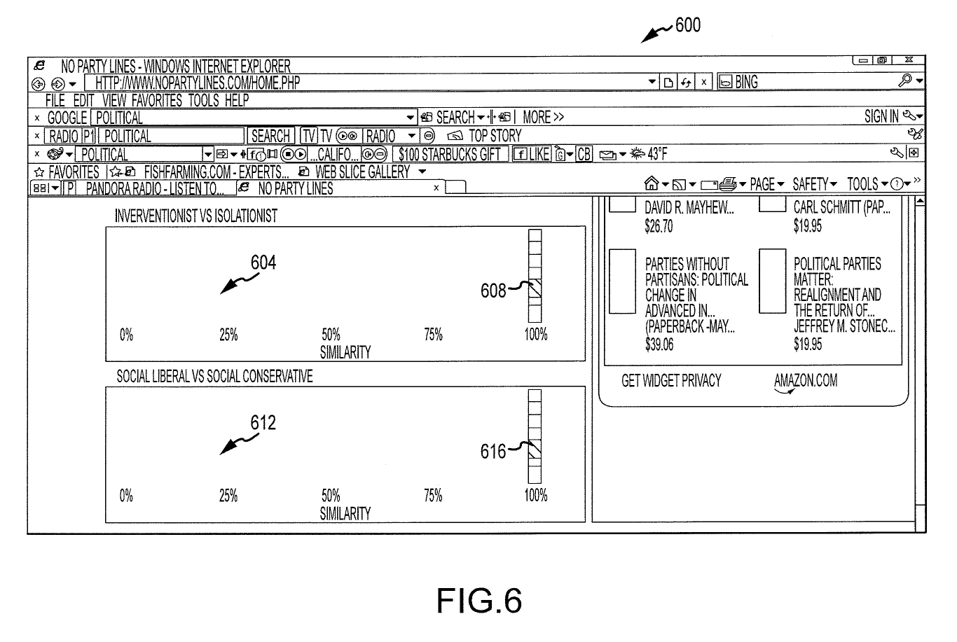

FIG. 6 represents a second portion 600 of the web page provided when political compass field 332 link is selected. The second portion 600 includes a first graph 604 indicating the position 608 of the requesting member relative to interventionist vs isolationist geopolitical views. The second portion 600 includes a second graph 612 indicating the position 616 of the requesting member relative to social liberal vs social conservative geopolitical views. In both the first and second graphs 604 and 612, other points are plotted above and below the positions 608 and 616, respectively. As in the first portion 500 of the web page, hovering over the point with a cursor causes the name of the corresponding member to appear. By selecting the point, the other member's profile is provided to the requesting member.

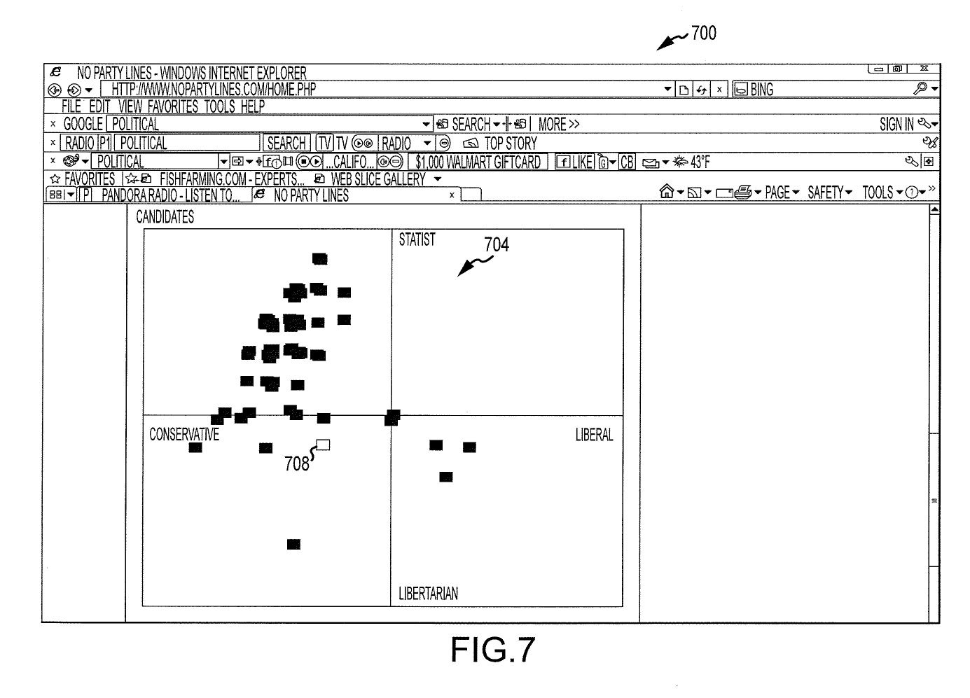

FIG. 7 represents a third portion 700 of the web page provided when political compass field 332 link is selected. The third portion includes a graph 704 plotting the requesting member's composite profile score on a political matrix relative to the composite profile scores of candidate members to indicate visually the degree to which the member and candidate is statist, conservative, liberal, or libertarian. The point 708 represents the point for the requesting member (John Doe). Each other point in the matrix indicates the point for a candidate having a profile in the service 132. By hovering over the point with a cursor, the name of the corresponding member appears. The point is a link that permits the requesting member to perform various operations, including “remove friend” (which removes the selected friend from the requesting member's friend sub-network), “add ally” (which adds the selected friend as an ally), and “send message” (which, when selected, opens up a send message box to send the friend a message). The link further provides news updates regarding the selected friend to the other member's public profile.

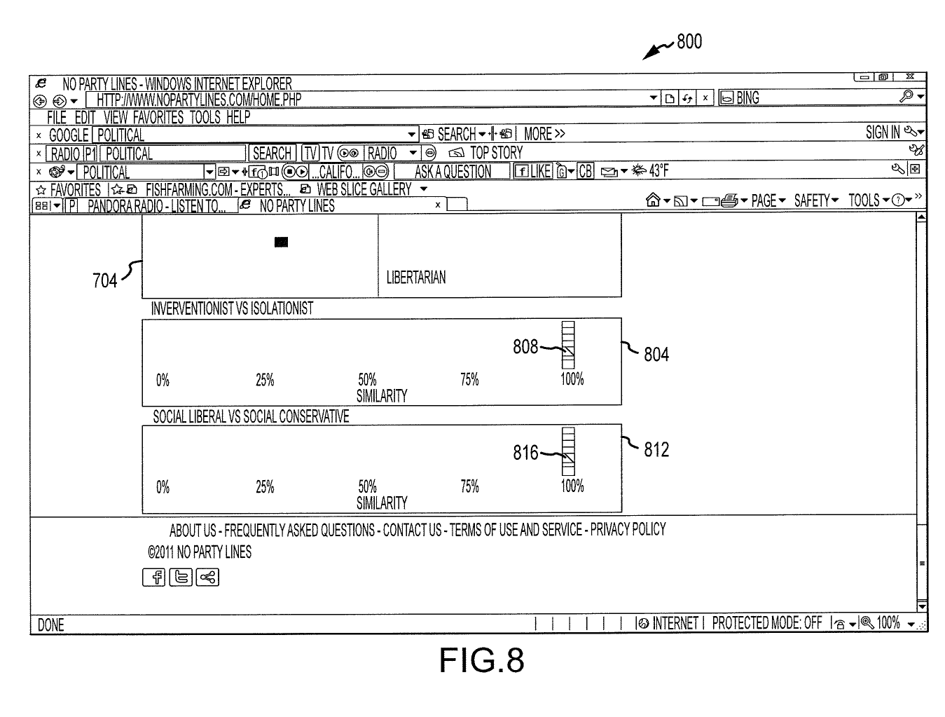

FIG. 8 represents a fourth portion 800 of the web page provided when political compass field 332 link is selected. The fourth portion 800 includes a first graph 804 indicating the position 808 of the requesting member relative to interventionist vs isolationist geopolitical views. The fourth portion 800 includes a second graph 812 indicating the position 816 of the requesting member relative to social liberal vs social conservative geopolitical views. In both the first and second graphs 804 and 812, other points are plotted above and below the positions 808 and 816, respectively. As in the first portion 500 of the web page, hovering over the point with a cursor causes the name of the corresponding candidate member to appear. By selecting the point, a link is selected permitting the requesting member to perform the operations discussed in the prior paragraph.

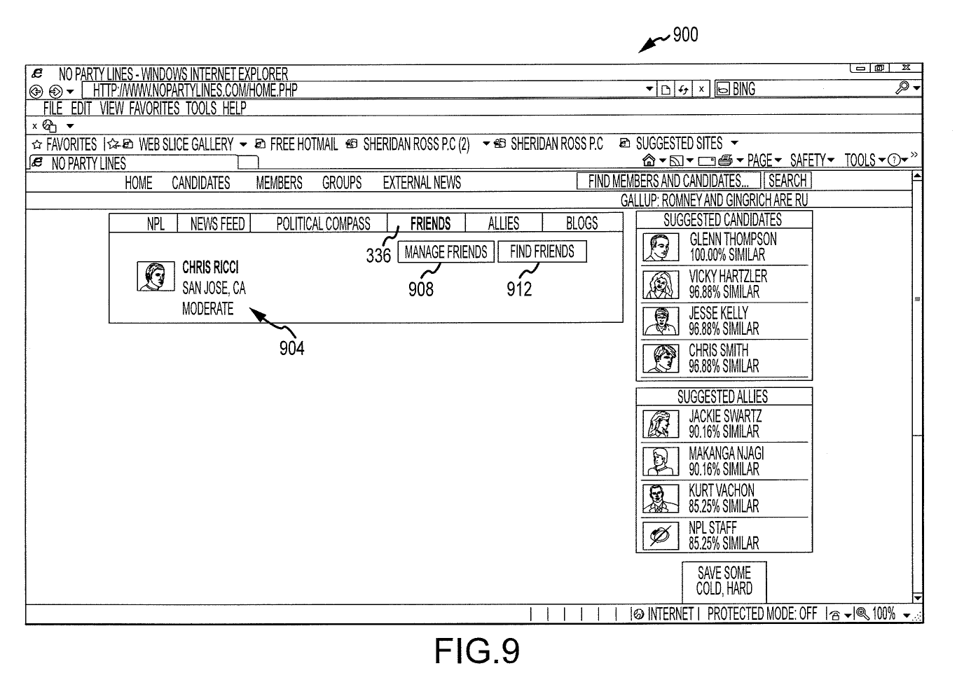

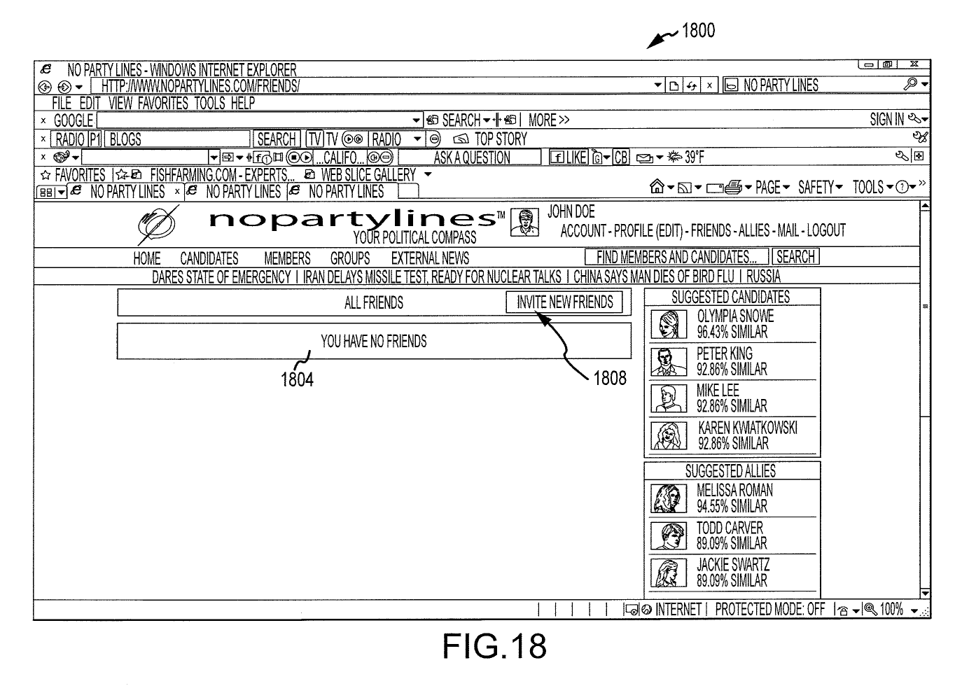

FIG. 9 shows the web page 900 provided when the friends field 336 link is selected. For each friend, a friend's name and a link (collectively referenced by 904) to his or her profile appears. Selection of the link permits the requesting member to perform the operations discussed above. Additionally, the web page 900 includes two menu options, namely to manage friends 908 and find friends 912. As shown by FIG. 18, selection of the manage friends 908 option provides a web page 1800 listing information 1804 about all friends of the requesting member and permits the requesting member to remove a send a selected friend a message, remove a selected friend, and invite 1808 a member to become a friend. The invitation includes requesting member's name, email address, potential friend's email address, and personal message fields. The find friends 912 option also provides the invitation for a member to become a friend.

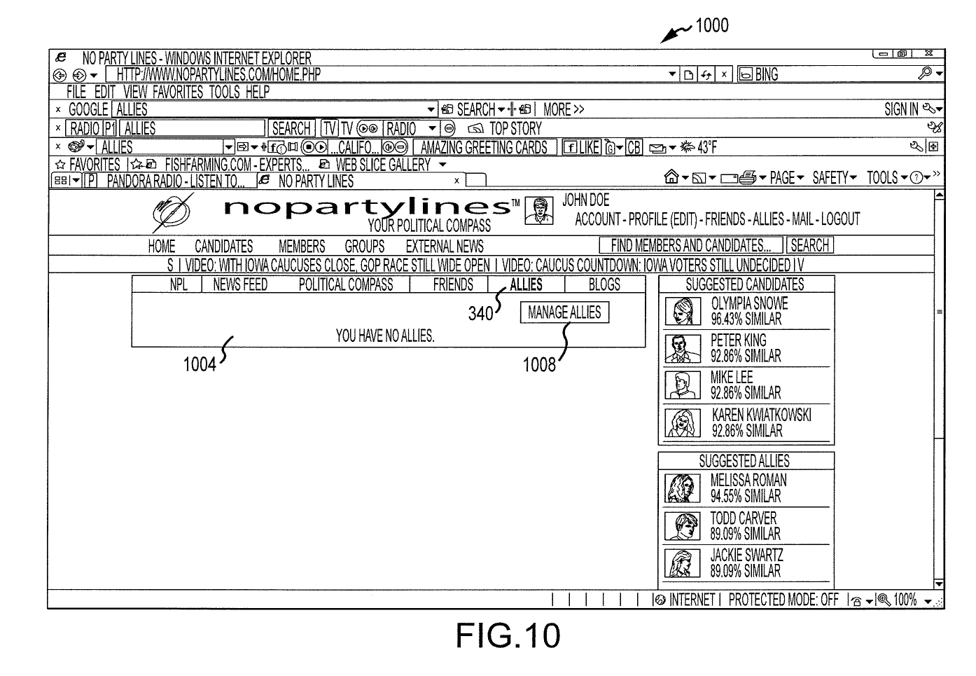

FIG. 10 shows the web page 1000 provided when the allies field 340 link is selected. For each ally, an ally's name and a link (collectively referenced by 1004) to his or her profile appears. Selection of the link permits the requesting member to perform the operations discussed above. Additionally, the web page 1000 includes a further menu option, namely to manage allies 1008. Manage allies 1008 lists all and suggested allies of the requesting member and permits the requesting member to remove a send a selected ally a message, remove a selected ally, and invite a member to become an ally. The invitation includes requesting member's name, email address, potential ally's email address, and personal message fields.

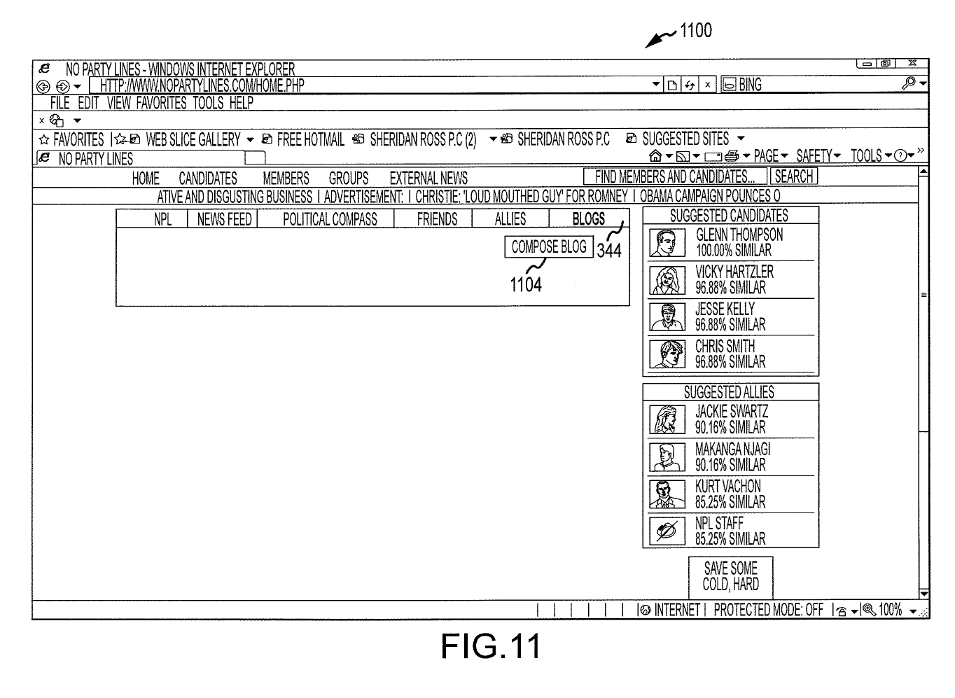

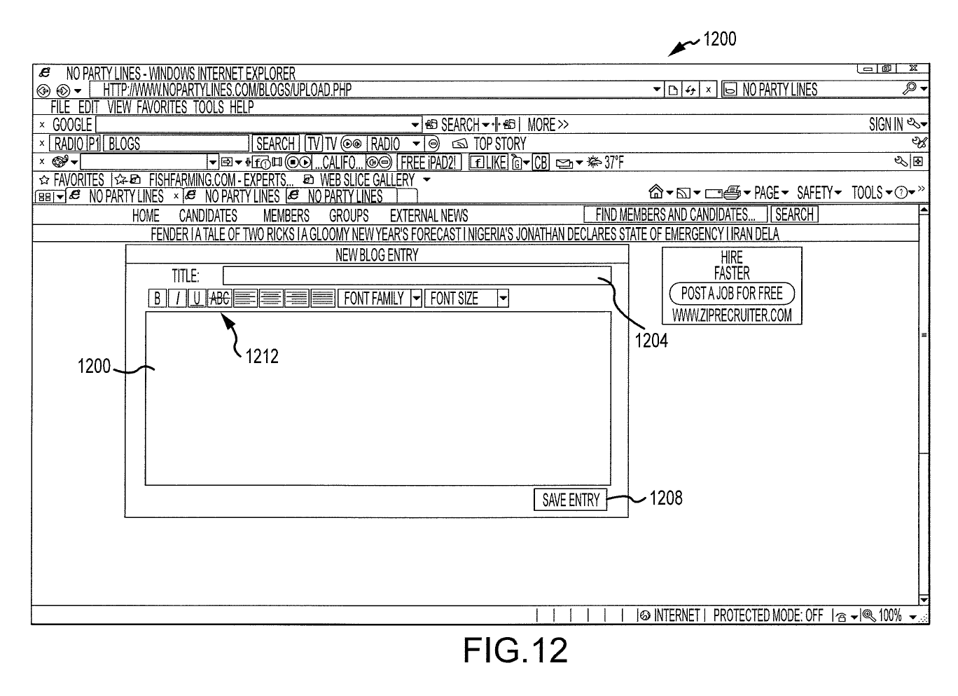

FIG. 11 shows the web page 1100 provided when the blog 344 link is selected. A compose blog link 1104 is provided. As shown in FIG. 12, the compose blog link 1104, when selected, provides a new blog entry 1200 comprising title and text fields 1204 and 1208 along with various formatting options 1212 and a “save entry” option 1208.

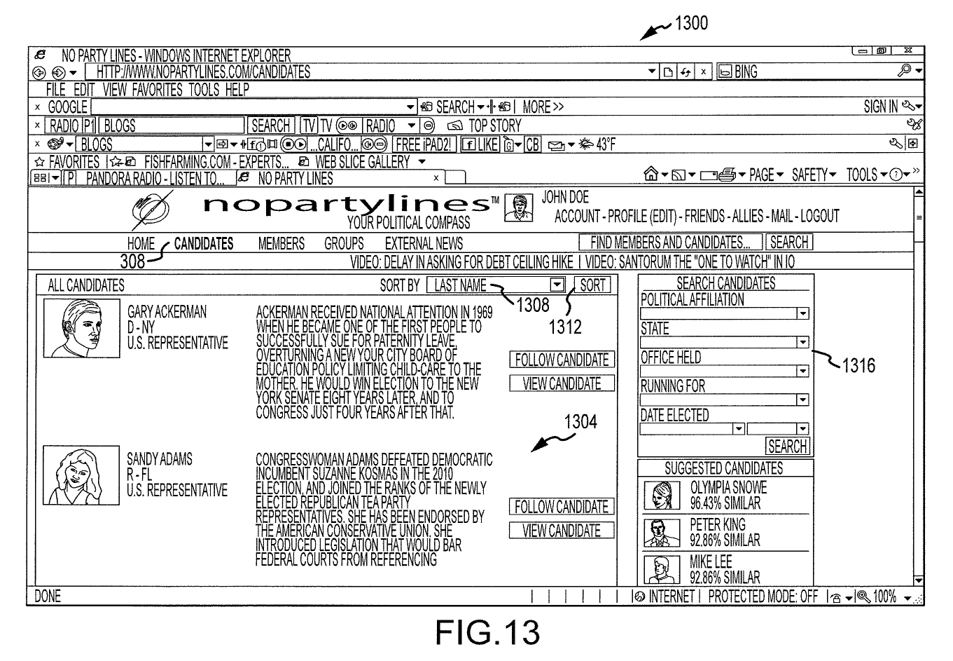

FIG. 13 shows the web page 1300 provided when the candidates 308 link is selected. Selected information 1304 about each of the candidate members are provided. The information 1304 includes the candidate's name, elected office or office for which the candidate is seeking election, the candidate's political party affiliation, a picture, and a short biography. Sorting options 1308 and command 1312 are provided to sort the candidate members in a desired manner. A series of search fields and command (collectively referenced by 1316) are also provided to enable the member to search through candidate profiles for selected candidates.

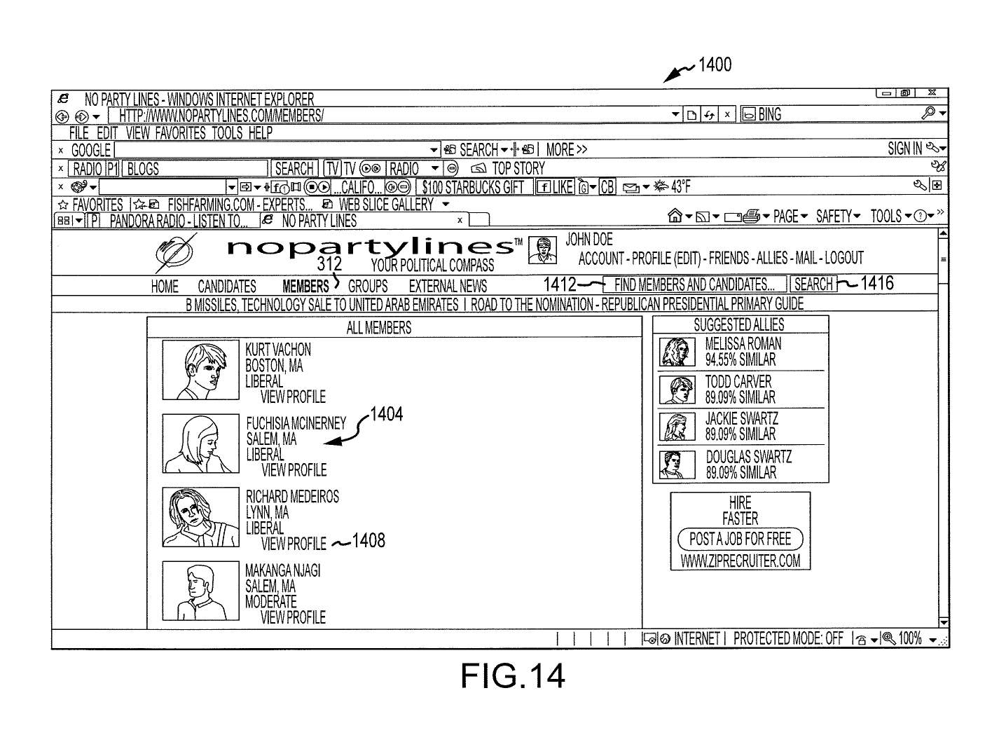

FIG. 14 shows the web page 1400 provided when the members 312 link is selected. Selected information 1404 about each of the members are provided. The information 1404 includes the member's name, residence, composite profile score (or political philosophy (e.g., liberal, moderate, conservative), and a “view profile” option 1408 to view the associated member's public profile. If the member's profile is private, the member's profile is not provided. A search field 1412 and associated command 1416 are provided to locate members and candidate members.

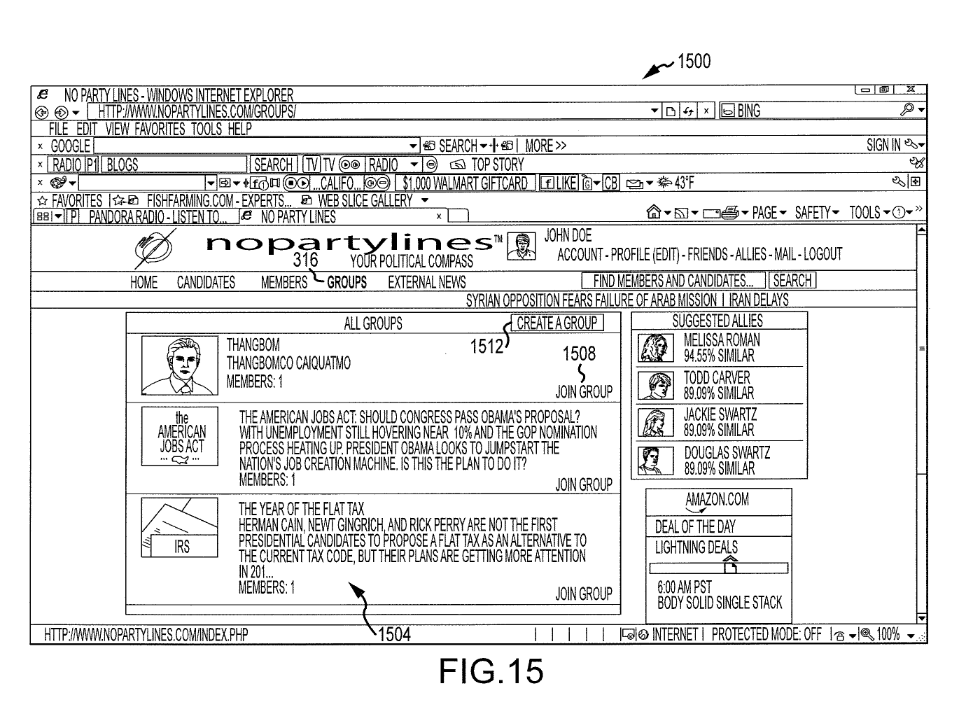

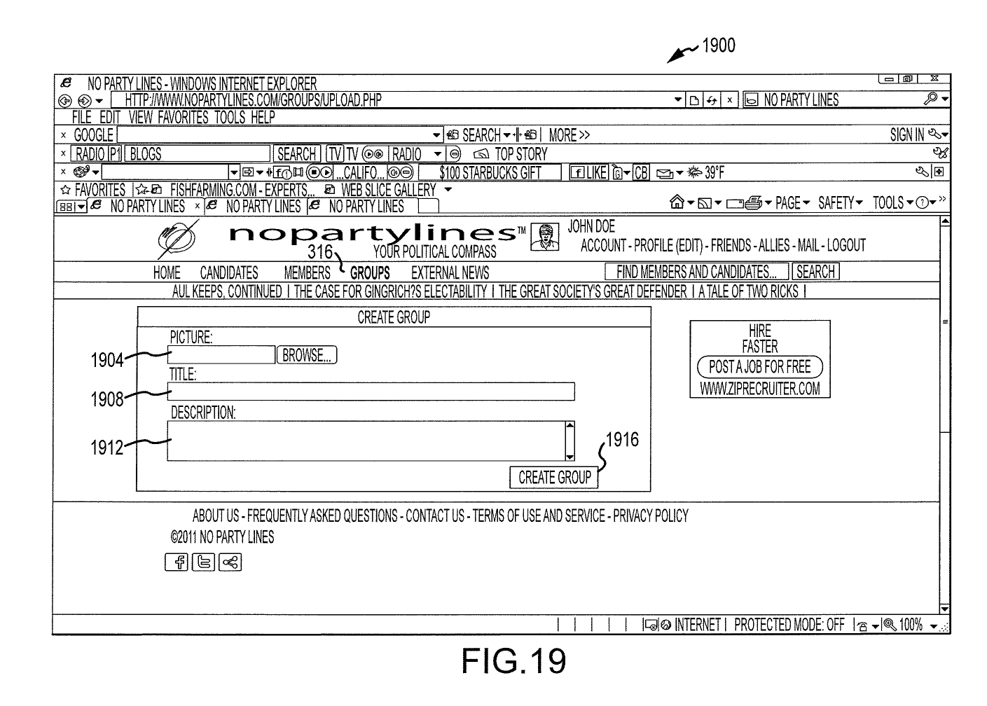

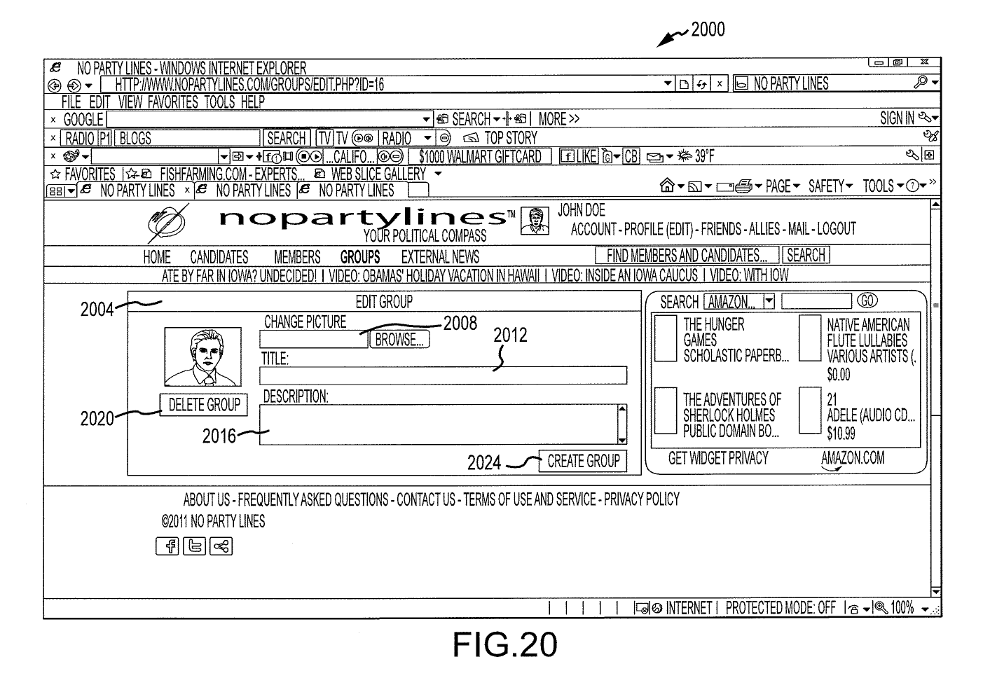

FIG. 15 shows the web page 1500 provided when the groups 316 link is selected. Selected information 1504 about each public group is provided. The selected information includes a picture, a group name, membership size, and a description of the group, including a statement of purpose. The information further includes an option 1508 to join the group. A create group option 1512 is provided to create a new group. Selection of this option 1512 provides a web page 1900, as shown in FIG. 19, comprising plural “create group” fields, including picture 1904, title 1908, and description 1912 with a command 1916 to create a group defined by the information populating the fields. The web page 2000 of FIG. 20 is provided to a requesting member to edit 2004 a group, created by the member. The editable fields include change picture 2008, title 2012, and description 2016. The web page 2000 further includes delete group and save group options 2020 and 2024.

FIG. 16 shows the web page 1600 provided when the external news 320 link is selected. Selected information 1604 about each news source is provided. The selected information 1604 includes news source logo, identity, and description. Selecting a news source links the requesting member with an external web page provided by the selected news source.

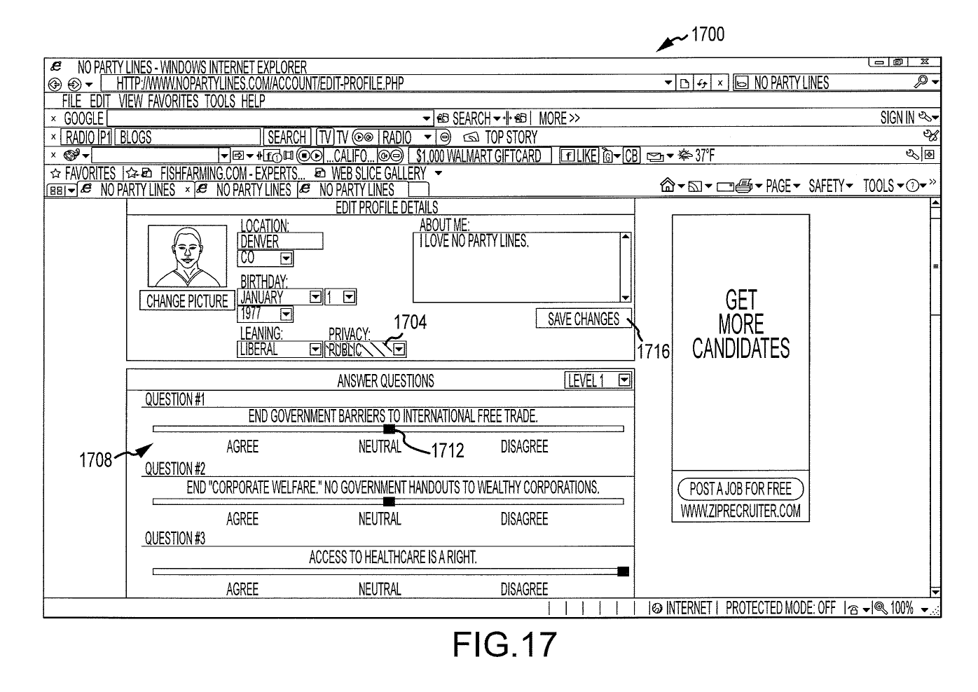

FIG. 17 shows the web page 1700 provided when the profile (edit) 352 link is selected. The web page includes plural fields, including member picture, member location, member birthday, member political philosophical leaning (as determined by the comparison module), privacy preference 1704, member self-description (about me), question number and member response 1708, and save changes option 1716. As can be seen from FIG. 17, the member's response is shown by the affordance 1712, which can be moved to the left or right by the member grabbing the affordance with the cursor.

Other portal configurations include fields for updates from, groups and/or candidates of interest.

By way of example, in another member portal configuration the portal is a home page allowing a member customizable view. The portal is personalized with the areas of the member's interest. On one side of the screen is a news feed providing news on issues of interest to the member. On the other side of the screen are fixed blocks dedicated for advertising. In the middle of the screen is a window for updates from groups and candidates of interest. This also allows others to post in response to those updates which are then filtered by the user's preferences. The user may indicate that they like another user's post which will prioritize his or her future posts to the user. Likewise, the user may indicate a dislike, which will lower the priority of the user on the list. There are also icons for the blogs, connections and the like. Posts on blogs can also be liked and disliked. All of this data is used to form the user's profile. In addition, there is a window showing the user's email.

Module Operations

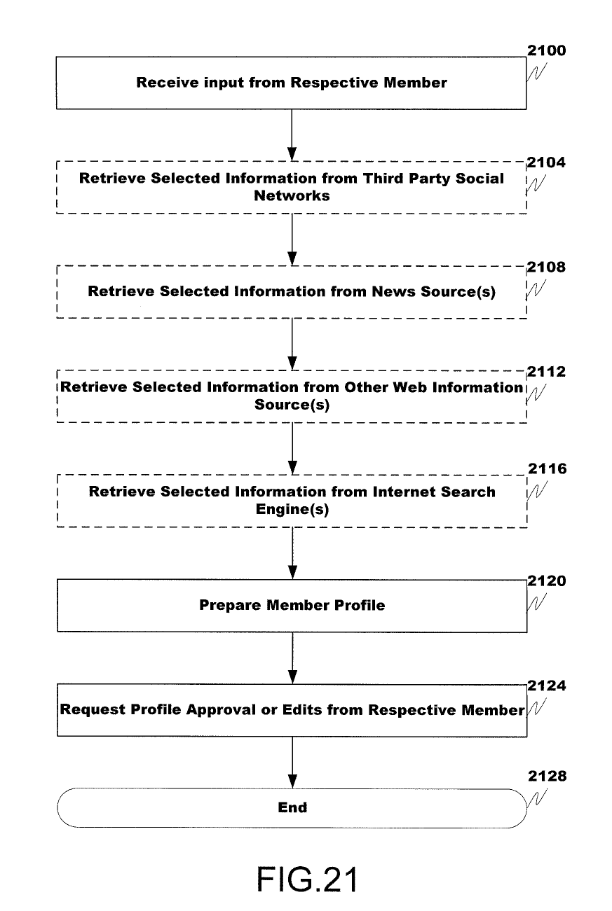

Referring to FIG. 21, the operation of the member profile module 204 is depicted according to an embodiment.

In step 2100, the member profile module 204 receives input from a respective current or newly registering member. The input is typically received by the member completing plural personal information fields and answering a selected level of questions as discussed previously.

In optional step 2104, the member profile module 204 retrieves selected information about the member from third party social networks 112.

In optional step 2108, the member profile module 204 retrieves selected information about the member from news source(s) 108.

In optional step 2112, the member profile module 204 retrieves selected information about the member from other web information source(s) 124.

In optional step 2116, the member profile module 204 retrieves selected information about the member from Internet search engine(s) 120.

In step 2120, the member profile module 204 prepares a profile for the member using the information collected in the preceding steps. In one configuration, the profile includes plural scores on an issue-by-issue basis. In one configuration, the profile includes a composite score over all issues.

In step 2124, the member profile module 204 provides the profile to the member and requests profile approval or receives edits from the respective member.

The member profile module 204 terminates operations with respect to the selected member profile in step 2128.

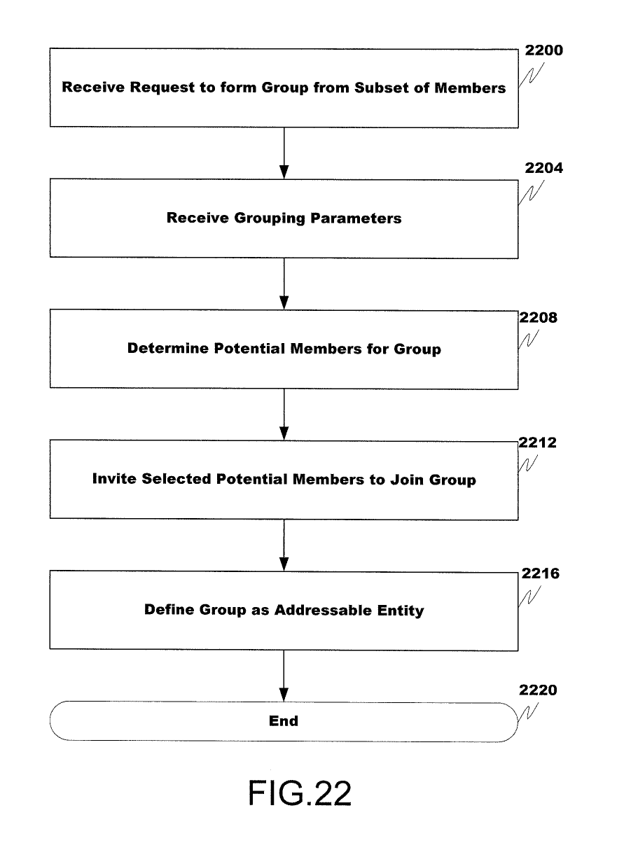

The operation of the grouping module 240 with respect to FIG. 22.

In step 2200, the grouping module 240 receives a request from a member to form a group comprising a subset of the members.

In step 2204, the grouping module 240 receives from the member creating the group the grouping parameters. The grouping parameters comprise the description of the group and characteristics of or other information regarding members to be invited to join the group. The characteristics can include search parameters to search the member profile database for potential group members.

In step 2208, the grouping module 240 determines, based on the grouping parameters, the potential group members.

In step 2212, the grouping module invites the selected potential group members to join the group.

In step 2216, the grouping module defines the group as an addressable entity. This means that the group has an electronic address, whereby it may be contacted by other members. The group electronic address is potentially linked to the group member addresses, such that a message to the group is propagated automatically to group members.

In step 2220, the grouping module terminates operation with respect to the selected group.

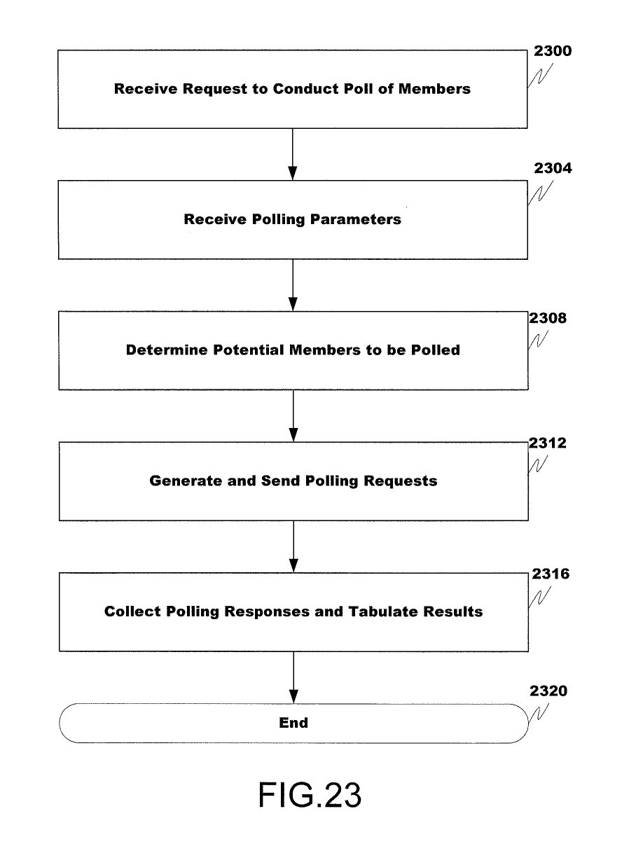

The operation of the polling module 268 will now be discussed with reference to FIG. 23.

In step 2300, the polling module 268 receives a request from a member to conduct a poll of all or a selected subset of members.

In step 2304, the polling module 268 receives the polling parameters from the requesting member. The polling parameters include the characteristics or definition of the members to be polled.

In step 2308, the polling module 268 determines, based on the polling parameters, the potential members to be polled.

In step 2312, the polling module 268 generates and sends polling requests to the identified members to be polled.

In step 2316, the polling module 268 collects polling responses and tabulates polling results. The report generation module 208 receives the polling responses and tabulated polling results and generates appropriate reports for presentation to the requesting member.

In step 2320, the polling module terminates operation with respect to the selected polling request.

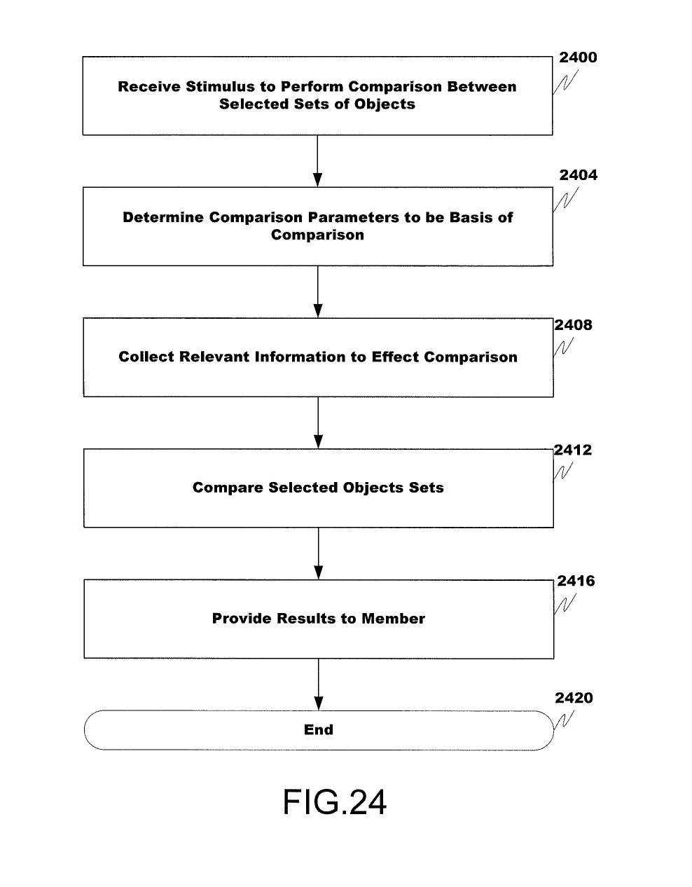

The operation of the comparison module 244 will now be discussed with reference to FIG. 24.

In step 2400, the comparison module 244 receives a stimulus to perform a comparison between selected sets of objects, such as members and political issues. The stimulus may be a request from a user or an automated interrupt or request from the service 132.

In step 2404, the comparison module 244 determines the comparison parameters to be the basis of the comparison. The comparison parameters generally are a function of the purpose of the comparison and refer to the particular fields in the profiles of the compared objects to be compared.

In step 2408, the comparison module 244 collects relevant information from the database 136 to effect the comparison.

In step 2412, the comparison module 244 compares the selected object sets.

In step 2416, the comparison module 244 provides the results to the requesting member or other requesting entity.

In step 2420, the comparison module 244 terminates operation with respect to the selected comparison.

A number of variations and modifications of the disclosure can be used. It would be possible to provide for some features of the disclosure without providing others.

For example in one alternative embodiment, the orientation social networking service 132 is used for political activities in addition to general elections. The service 132 can perform any of the functions set forth above, for, instance, with reference to political primaries and other similar functions. A primary election is an election in which party members or voters select candidates for an election. Primary elections are one means by which a political party nominates candidates for the next general election. Primaries are common in the United States, where their origins are traced to the progressive movement. Primary elections are usually the responsibility of political party organizations themselves and not the government. Other methods of selecting candidates include caucuses, conventions, and nomination meetings. Historically, Canadian political parties chose their candidates through nominating conventions held by constituency riding associations. Canadian party leaders are elected at leadership conventions, although some parties have abandoned this practice in favor of one member, one vote systems.

In another alternative embodiment, aspects of the orientation social networking service 132 are offered as a personal political advisor to a user, who may elect not to network with other members of the service 132. The personal political advisor functionality, for instance, would receive a profile of the user, use the profile to predict positions of the user on issues and/or candidates, provide a sample ballot with recommended voting positions on each issue or candidate, provide to the user news content of interest to the user (which may be based on user preferences or the user's profile), provide the user with times and dates for voting, provide, using the user's residential or other address information and/or geolocation information from a communication device of the user, the user with maps or directions, such as by Googlemaps™, to a nearest polling location for casting a vote or ballot or participating in a political caucus. The personal political advisor would have a networking option, which, if selected, would enable, for that user, the remaining functionality of the orientation social networking service 132.

In another embodiment, a notification module (not shown) is used to inform selected members in real time of determined political issues or events that potentially impact the selected members. For example, a political event could be a municipal, state, or federal vote by a governmental entity on legislation or other political issue. It would be useful for a candidate or lobbying firm to know the intensity and opinion of the membership or a part thereof to an issue or as a constituency, particularly in real time.

In another embodiment, a petition module is provided. The petition module would publish or otherwise present a petition or petition link to members generally or having particularly political philosophies, beliefs or affiliations. The signatures to the petition could be verified by the petition module and provided, by the petition module, to a governmental entity for verification or validation. The petition module is not limited to petitions but could publish or solicit other forms of political expression to candidates and other political leaders, such as automatically generate and provide letters and other communications to the candidate and/or other political leaders. The present disclosure describes, in some embodiments, a social network that relies on member-provided data to provide a personalized experience and services that are aligned with each member's political ideologies. For example, the power of social networks in politics has recently been illustrated by the overthrow of the Egyptian government. Facebook™ was clearly an important component in that particular political process and demonstrates the ability of people, even in repressive regimes, to effect change. This demonstration of social networking power may not have come to light had a political situation not reached a breaking point. A fair question is how social networking might be harnessed for change in Western democracies. In the UK, ePetitions is an online website that allows the public to start petitions around any topic of concern. A recent e-petition calling for rioters to lose their benefits hit 100,000 signatures and became the first to be considered for a Commons debate. Beyond the non-partisan blogging, debating, information gathering, and socializing, voters are in desperate need of something that gives them the power to bring about change. Short of voting or joining a group, what opportunities do voters have? Even supporting or joining an activist group falls short in, delivering evidence that your participation mattered. A petition module could empower voters. A petition is viewed as a more powerful instrument for change than is a simple debate. There is stronger impetus for those supporting a petition to solicit signers and share the posting. The petition would prompt debate as opponents of the petition voiced their concerns about adoption. The petition module could have an “associated” thread for those undecided voters. The petition feature would require an established line of communication to political law makers and news reporters. The graphics associated with this feature can provide instant gratification to voters. The petition efforts of the petition module can provide graphic displays of the success of the petition drive (e.g., how many members have signed the petition). In one example, a set of members, constituting a college group, author a “bill” that is disseminated by that group via the petition module. The petition module has a section dedicated to creating issue “ground-swell”. In that section, members and even non-members can support the initiative. A graphic measurement tool can allow members to monitor the level of support behind the initiative. A predetermined tipping point triggers the bill being forwarded to all congressional members.

The exemplary systems and methods of this disclosure have been described in relation to computational systems. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In another embodiment, the systems and methods of this disclosure can be implemented in conjunction with a special purpose computer; a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the system in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claims. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within, the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
receiving, by a processor executable orientation social networking service, a profile of a selected user, the profile indicating a set of orientations of the selected user;
comparing, by the processor executable orientation social networking service, a selected portion of the selected user's profile against selected portions of profiles of a plurality of other users, the plurality of other users comprising users having a similar and/or dissimilar orientation to the selected user;
identifying, by the processor executable orientation social networking service and based on the comparing step, a set of other users having a selected one of a similar and dissimilar orientation to the selected user; and
forming a social network among the selected user and the set of other users, wherein the set of orientations comprises one or more of a political belief, religious belief, and sexual inclination.

2. The method of claim 1, wherein the set of orientations comprises a religious belief and wherein the plurality of other users are members of differing social networks.

3. The method of claim 1, wherein the set of orientations comprises a sexual inclination and wherein the plurality of other users are members of differing social networks.

4. The method of claim 1, wherein the set of orientations comprises a political belief, wherein the plurality of users comprise a plurality of voters, candidates, lobbyists, and influencers, and wherein the plurality of users comprise members of differing political parties.

5. The method of claim 4, wherein, in the forming step, the social network among the selected user and the set of other users characterizes the selected user and the set of other users as one of friends, allies, and adversaries.

6. The method of claim 4, further comprising:
comparing, by the processor executable orientation social networking service, a selected portion of the selected user's profile against a selected portion of a profile of a candidate and/or political party and/or ballot issue to determine a degree of at least one of similarity and dissimilarity between the selected user's orientation and an orientation of the candidate and/or political party and/or ballot issue, wherein the candidate and/or political party and/or ballot issue is selected for comparison by the processor executable orientation networking service based on a geographical and/or geopolitical location of the selected user; and
based on the comparing step, providing, by the processor executable orientation social networking service, to the selected user a voting recommendation with respect to the candidate and/or political party and/or ballot issue.

7. The method of claim 4, further comprising at least one of the following steps:
providing, by the processor executable orientation social networking service, news content to the selected user, the news content at least one of being selected by the user and based on the selected user's profile;
generating, by the processor executable orientation social networking service, the profile based on the selected user's responses to a predetermined sets of questions respecting the selected user's political beliefs, each predetermined set of questions corresponding to a selected one of the political beliefs;
obtaining, by the processor executable orientation social networking service and from a third party networked source, information for the selected user's profile, wherein the third party networked source is one or more of a selected user profile maintained by an on-line community, a personal website of the user, and a presence service associated with the user; and
maintaining, by the processor executable orientation social networking service, multiple blogs respecting opposing sides of a selected political issue, wherein blog recipients are selected based on user profiles.

8. The method of claim 7, wherein the generating step is performed and wherein the selected user's responses to the predetermined sets of questions are weighted based on an assigned strength and/or importance and/or reliability of each response.

9. The method of claim 8, wherein the processor executable orientation social networking service maintain separate scores for assigned strength and importance of each response.

10. The method of claim 8, wherein multiple levels of predetermined sets of questions have multiple reliability levels.

11. The method of claim 4, further comprising:
determining, by the processor executable orientation social networking service and from profiles of members of a selected set of the plurality of users, a profile of an average user.

12. The method of claim 1, further comprising:
providing each of the plurality of users with a home page, the home page comprising a live news feed from a news source, a political compass indicating the respective user's political beliefs relative to at least one other user of the plurality of users and/or relative to an orientation, a first set of users designated as friends and/or prospective friends of the respective user, a second different set of users designated as one of current and/or prospective allies and adversaries of the respective user, and a blog selected based on the profile of the respective user, wherein different users can receive different blogs.

13. A non-transient computer readable medium comprising processor executable instructions to perform the steps of claim 1.

14. A computational system operable to perform the steps of claim 1.

15. A method, comprising:
comparing, by a processor executable orientation social networking service and/or a personal political advisor, a selected portion of a selected user's profile against selected information respecting a selected object, the selected object being at least one of a candidate, a member of an organization, a political party platform, a political issue, and a ballot issue; and
based on the comparing step, providing, by the processor executable orientation social networking service and/or a personal political advisor, a voting recommendation for consideration by the selected user.

16. The method of claim 15, wherein the selected object is at least one of a candidate for office and organization member and the selected information is at least a portion of a profile of the at least one of a candidate for office and organization member and further comprising:
determining, based on the comparing step and by the processor executable orientation social networking service, a level of similarity and/or dissimilarity between the selected user and the selected one of a candidate for office and organization member.

17. The method of claim 15, wherein the selected object is at least one of a political party platform, a political issue, and a ballot issue and further comprising:
determining, based on the comparing step and by the processor executable orientation social networking service, a level of similarity and/or dissimilarity between the selected user and the selected one of a political party platform, a political issue, and a ballot issue.

18. The method of claim 15, further comprising:
receiving a response, by the processor executable orientation social networking service and from the selected user, to the recommendation; and
providing, by the processor executable orientation social networking service, the response to an election monitor as part of casting a ballot.

19. A non-transient computer readable medium comprising processor executable instructions to perform the steps of claim 15.

20. A computational system operable to perform the steps of claim 15.
